(19) United States
(12) Patent Application Publication
(10) Pub. No.: US 2016/0054496 A1
(43) Pub. Date: Feb. 25, 2016

(54) CIRCULARLY POLARIZED LIGHT SEPARATION FILM, METHOD FOR PRODUCING CIRCULARLY POLARIZED LIGHT SEPARATION FILM, INFRARED SENSOR, AND SENSING SYSTEM AND SENSING METHOD UTILIZING LIGHT

(71) Applicant: FUJIFILM CORPORATION, Tokyo (JP)

(72) Inventors: Mitsuyoshi ICHIHASHI, Ashigarakami-gun (JP); Wataru MAJIMA, Ashigarakami-gun (JP); Kazuhiro OKI, Ashigarakami-gun (JP)

(73) Assignee: FUJIFILM CORPORATION, Tokyo (JP)

(21) Appl. No.: 14/932,346

(22) Filed: Nov. 4, 2015

Related U.S. Application Data
(63) Continuation of application No. PCT/JP2014/062258, filed on May 7, 2014.

(30) Foreign Application Priority Data
May 8, 2013 (JP) 2013-098633
May 8, 2013 (JP) 2013-098634
May 8, 2013 (JP) 2013-098635

(51) Int. Cl. G02B 5/30; B05D 7/00; B05D 5/06; G01J 4/04; B05D 3/06

(52) U.S. Cl. CPC G02B 5/3025; G01J 4/04; G02B 5/3016; B05D 3/065; B05D 5/06; B05D 7/544

(57) ABSTRACT

The invention provides: a circularly polarized light separation film which selectively allows the transmission of any one of right circularly polarized light and left circularly polarized light in at least a part of a near infrared light wavelength range and includes a visible light shielding layer which reflects or absorbs light in at least a part of a visible light wavelength range and a circularly polarized light separation layer which selectively allows the transmission of any one of right circularly polarized light and left circularly polarized light in at least a part of a near infrared light wavelength range; a manufacturing method of the circularly polarized light separation film; an infrared sensor including the circularly polarized light separation film; and a sensing system and a sensing method utilizing the circularly polarized light separation film or a combination of the circularly polarized light separation film and a film including the visible light shielding layer. The sensing system and the sensing method provides high sensitivity regardless of the surrounding environment and causing fewer sensing errors.

### CROSS-REFERENCE TO RELATED APPLICATIONS

This application is a continuation of PCT International Application No. PCT/JP2014/062258 filed on May 7, 2014, which claims priorities under 35 U.S.C §119 (a) to Japanese Patent Applications Nos. 2013-098633, 2013-098634, and 2013-098635 filed on May 8, 2013, the entire contents of which are incorporated herein by reference.

### BACKGROUND OF THE INVENTION

1. Field of the Invention

The present invention relates to a circularly polarized light separation film, a method for producing a circularly polarized light separation film, an infrared sensor, and a sensing system and a sensing method utilizing light.

2. Description of the Related Art

A sensing system utilizing polarized light in an infrared region is known in the related art. For example, in JP2008-58270A, cracks on a silicon substrate are detected with a system of irradiating the silicon substrate with polarized infrared light through a first linear polarizing filter and receiving reflected light or transmitted light from the silicon substrate through a second linear polarizing filter. The light intensity which can be sensed decreases, when the reflected light or transmitted light of a portion without cracks is linearly polarized light and travels through the second linear polarizing filter, except for in a case where specific conditions are satisfied, however, this technology is acquired by using a phenomenon that light which can be sensed is generated even when the reflected light or transmitted light on the portion with cracks travels through the second linear polarizing filter due to diffuse reflection. JP2003-96850A discloses an automatic faucet device which senses the hand of a person or an object using infrared light and prevents erroneous sensing using first polarizing means for allowing transmission of a linear polarized light component of floodlit infrared light and second polarizing means for allowing transmission of a linear polarized light component of infrared light emitted.

In JP2013-36888A, a technology utilizing circularly polarized light is disclosed in the technology of JP2008-58270A. By utilizing the circularly polarized light, it is not necessary to adjust a polarizing direction of the second linear polarizing filter.

### SUMMARY OF THE INVENTION

A sensing system utilizing polarized light in an infrared wavelength range may be used in various light environments. An object of the invention is to provide a sensing system for providing high sensitivity regardless of the surrounding environment and causing fewer sensing errors, as the sensing system utilizing polarized light in an infrared wavelength range. Another object of the invention is to provide a sensing method for providing high sensitivity regardless of the surrounding environment and causing fewer sensing errors, as a sensing method utilizing polarized light in an infrared wavelength range. Still another object of the invention is to provide a film which can be used in such a system.

In order to achieve the objects described above, the inventors have studied a sensing system utilizing polarized light in an infrared wavelength range. The inventors have found that a light receiving element also detects light in a visible light region to cause sensing errors, even in a case of performing sensing using a sensor including a light receiving element which senses infrared light. The inventors further have performed intensive research based on this knowledge and completed the invention. That is, the invention provides the following [1] to [26].

[1] circularly polarized light separation film which selectively allows the transmission of any one of right circularly polarized light and left circularly polarized light in at least a part of a near infrared light wavelength range, the film including: a visible light shielding layer which reflects or absorbs light in at least a part of a visible light wavelength range; and a circularly polarized light separation layer which selectively allows the transmission of any one of right circularly polarized light and left circularly polarized light in at least a part of a near infrared light wavelength range.

[2] The circularly polarized light separation film according to [1], in which at least a part of the near infrared light wavelength range is a wavelength range having a width equal to or greater than 50 nm from the range of a wavelength of 800 nm to 1500 nm, and at least a part of the visible light wavelength range is a wavelength range having a width equal to or greater than 50 nm from the wavelength range of 380 nm to 780 nm:

[3] The circularly polarized light separation film according to [1] or [2], in which average light transmittance in the range of a wavelength of 380 nm to 780 nm is equal to or smaller than 5%, and in the range having a width equal to or greater than 50 μm from the range of a wavelength of 800 nm to 1500 nm, light transmittance of any one of the right circularly polarized light and left circularly polarized light is equal to or smaller than 10% and light transmittance of the other circularly polarized light is equal to or greater than 90%.

[4] The circularly polarized light separation film according to any one of [1] to [3], in which the visible light shielding layer is a visible light reflection layer selected from a group consisting of a layer obtained by fixing a cholesteric liquid-crystalline phase and a dielectric multilayer film.

[5] The circularly polarized light separation film according to any one of [l] to [3], in which the visible light shielding layer is a visible light absorption layer including a pigment or a dye.

[6] The circularly polarized light separation film according to any one[1] to [5], in which the circularly polarized light separation layer is a layer obtained by fixing a cholesteric liquid-crystalline phase.

[7] The circularly polarized light separation film according to any one of [1] to [5], in which the circularly polarized light separation layer includes a linearly polarized light separation layer and a layer having a phase difference (Re) in the range having a width equal to or greater than 50 nm from the range of a wavelength of 800 nm to 1500 nm is from 200 nm to 375 nm.

[8] A manufacturing method of the circularly polarized light separation film according to any one of [1] to [6], in which the circularly polarized light separation layer is formed by a method including the following (1) to (3): (1) applying a liquid crystal composition including a polymerizable liquid crystal compound and a chiral agent to a base material; (2) drying the liquid crystal composition coated on a substrate in (1) to form a cholesteric liquid-crystalline phase; and (3) fixing the cholesteric liquid-crystalline phase by heating or light irradiation.

[9] The manufacturing method of the circularly polarized light separation film according to [8], in which the circularly polarized light separation layer is formed by a method including the following (11) to (13): (11) directly applying the liquid crystal composition including the polymerizable liquid crystal compound and the chiral agent to a surface of a layer obtained by fixing the cholesteric liquid-crystalline phase obtained in (3); (12) drying the liquid crystal composition coated on a substrate in (11) to form a cholesteric liquid-crystalline phase; and (13) fixing the cholesteric liquid-crystalline phase formed in (12) by heating or light irradiation.

[10] The manufacturing method according to [9], in which the polymerizable liquid crystal compound and the chiral agent of (1) respectively are the same as the polymerizable liquid crystal compound and the chiral agent of (11).

[11] The manufacturing method according to any one of [8] to [10], further including: bonding a visible light shielding layer to the surface of the layer obtained by fixing the cholesteric liquid-crystalline phase using an adhesive.

[12] The manufacturing method according to any one of [8] to [10], further including: bonding a visible light shielding layer to the surface of the base material using an adhesive.

[13] A manufacturing method of the circularly polarized light separation film according to any one of [1] to [6], in which the circularly polarized light separation layer is formed by a method including the following (21) to (23): (21) applying a liquid crystal composition including a polymerizable liquid crystal compound and a chiral agent to a visible light shielding layer; (22) drying the liquid crystal composition coated on the visible light shielding layer in (21) to form a cholesteric liquid-crystalline phase; and (23) fixing the cholesteric liquid-crystalline phase by heating or light irradiation.

[14] The manufacturing method of the circularly polarized light separation film according to [13], in which the circularly polarized light separation layer is formed by a method including the following (31) to (33): (31) directly applying the liquid crystal composition including the polymerizable liquid crystal compound and the chiral agent to a surface of a layer obtained by fixing the cholesteric liquid-crystalline phase obtained in (23); (32) drying the liquid crystal composition coated on a substrate in (31) to form a cholesteric liquid-crystalline phase; and (33) fixing the cholesteric liquid-crystalline phase formed in (32) by heating or light irradiation.

[15] The manufacturing method according to [14], in which the polymerizable liquid crystal compound and the chiral agent of (21) respectively are the same as the polymerizable liquid crystal compound and the chiral agent of (31).

[16] An infrared sensor including: the circularly polarized light separation film according to any one of [1] to [7]; and a light receiving element which can detect light at a wavelength in which the circularly polarized light separation film selectively allows the transmission of any one of right circularly polarized light and left circularly polarized light.

[17] A system for sensing a target object by irradiating the target object with light and detecting reflected light or transmitted light of the target object derived from the light irradiation, the system including: a light source; a circularly polarized light separation film 1; a circularly polarized light separation film 2; and a light receiving element which detects light at wavelengths of a near infrared light wavelength range, in which either of the circularly polarized light separation film 1 and the circularly polarized light separation film 2 selectively allows the transmission of either one of right circularly polarized light and left circularly polarized light at least in a part of a near infrared light wavelength range, the circularly polarized light separation film 1 may serves as the circularly polarized light separation film 2, the light source, the circularly polarized light separation film 1, the circularly polarized light separation film 2, and the light receiving element are arranged so that light supplied from the light source is transmitted through the circularly polarized light separation film 1 and is emitted to the target object and the light transmitted through or reflected by the target object is transmitted through the circularly polarized light separation film 2 and is detected by the light receiving element, and the circularly polarized light separation film 2 is the circularly polarized light separation film according to any one of [1] to [7].

[18] The system according to [17], in which the circularly polarized light separation film 1 is the circularly polarized light separation film according to any one of [1] to [7].

[19] The system according to [17] or [18], in which the light source is a near infrared light source.

[20] The system according to any one of [17] to [19], which senses the target object through glass, in which the light source, the circularly polarized light separation film 1, the circularly polarized light separation film 2, and the light receiving element are arranged so that the reflected light of the target object derived from the light of the light source is transmitted through the circularly polarized light separation film 2 and is detected by the light receiving element.

[21] The system according to any one of [17] to [19], in which the target object is a transparent film, and the light source, the circularly polarized light separation film 1, the circularly polarized light separation film 2, and the light receiving element are arranged so that the transmitted light of the target object derived from the light of the light source is transmitted through the circularly polarized light separation film 2 and is detected by the light receiving element.

[22] The system according to any one of [17] to [21], in which an optical axis of the reflected light or the transmitted light of the target object derived from the light of the light source forms an angle of 70° to 89° to the circularly polarized light separation film 2.

[23] A method of irradiating a target object and sensing the target object by reflected light or transmitted light of the target object derived from the light irradiation, the method including: (1) irradiating the target object with circularly polarized light in a near infrared light wavelength range selectively containing any one of right circularly polarized light and left circularly polafized light; and (2) detecting light of which at least a part of light which is generated by reflection of the circularly polarized light by the target object or transmission of the circularly polarized light through the target object and is transmitted through a circularly polarized light separation layer 2 and a visible light shielding layer 2, by a light receiving element which detects light at wavelengths of the near infrared light wavelength range, in which the circularly polarized light separation layer 2 selectively allows the transmission of any one of right circularly polarized light and left circularly polarized light at least in a part of a near infrared light wavelength range, and the visible light shielding layer 2 reflects or absorbs light in a wavelength range at least in a part of a visible light wavelength range.

[24] The method according to [23], in which any of the circularly polarized light separation layer 2 and the visible light shielding layer 2 is a layer configuring the same film.

[25] The method according to [23] or [24], in which at least a part of the light beam which is generated by being reflected by the target object or being transmitted through the target object in (2) is transmitted through the circularly polarized light separation layer 2 and the light shielding layer 2 in this order.

[26] The method according to any one of [23] to [25], in which the circularly polarized light in the near infrared light wavelength range of (1) is light formed by being transmitted through a visible light shielding layer 1 and a circularly polarized light separation layer 1, the circularly polarized light separation layer 1 is a layer which selectively allows the transmission of any one of right circularly polarized light and left circularly polarized light in at least a part of a near infrared light wavelength range, and serves as the circularly polarized light separation layer 2, and the visible light shielding layer 1 is a layer which reflects or absorbs light in a wavelength range at least in a part of a visible light wavelength range, and serves as the visible light shielding layer 2.

With the invention, a sensing system and a sensing method utilizing polarized light in an infrared light range, the system and the method for providing high sensitivity regardless of the surrounding environment and causing fewer sensing errors are provided. In addition, a circularly polarized light separation film which can be used in the sensing system and the sensing method is provided.

### BRIEF DESCRIPTION OF THE DRAWINGS

FIG. 1 is a diagram showing arrangement examples of a light source, a light receiving element, and a circularly polarized light separation film for sensing a target object by a method of the invention.

FIG. 2 is a diagram schematically showing arrangement of the film, the light source, the light receiving element, and a mirror used in Examples.

### DESCRIPTION OF THE PREFERRED EMBODIMENTS

Hereinafter, the invention will be described in detail.

In addition, a term “to” in this specification is used to include numerical values noted before and after the term as a lower limit value and an upper limit value.

In this specification, a term “selectively” used when describing circularly polarized light means that the light intensity of any one of a right circularly polarized light component and a left circularly polarized light component of emitted light is greater than the light intensity of the other circularly polarized light component. Specifically, when using the term “selectively”, a degree of circular polarization of light is preferably equal to or greater than 0.3, more preferably equal to or greater than 0.6, and even more preferably equal to or greater than 0.8. The degree of circular polarization of light is substantially even more preferably 1.0.

Herein, when an intensity of the right circularly polarized light component of the light is set as I_{R} and an intensity of the left circularly polarized light component is set as I_{L}, the degree of circular polarization is a value represented as |I_{R}−I_{L}|/(I_{R}+I_{L}).

In this specification, a term “sense” used when describing circularly polarized light means the circularly polarized light is right circularly polarized light or left circularly polarized light. When the light is seen so that the light travels towards the front side, the sense of the circularly polarized light is defined as right circularly polarized light, in a case where a distal end of an electric field vector rotates clockwise according to passage of time, and is defined as left circularly polarized light, in a case where the distal end thereof rotates counterclockwise.

In this specification, the twin “sense” may be used for a torsion direction of a spiral of a cholesteric liquid crystal. Regarding selective reflection by the cholesteric liquid crystal, right circularly polarized light is reflected and left circularly polarized light is transmitted, in a case where the torsion direction of the spiral of the cholesteric liquid crystal (sense) is right, and left circularly polarized light is reflected and right circularly polarized light is transmitted, in a case where the sense is left.

Visible light is light having wavelengths which are visually recognizable by a person among electromagnetic waves and indicates light in a wavelength range of 380 nm to 780 nm.

Infrared light (infrared light beam) is electromagnetic waves in a wavelength range which is longer than that of visible light and shorter than radiowaves. Near infrared light is electromagnetic waves in a wavelength range of 700 nm to 2500 nm. The wavelength range of near infrared light is preferably 780 nm to 1500 nm or 800 nm to 1500 nm. In general, near infrared light may have a wavelength range corresponding to a wavelength range of near infrared light which is used in an infrared camera, an infrared photoelectric sensor, infrared communication, or the like.

In this specification, the measurement of a necessary light intensity in relation to calculation of light transmittance may be, for example, performed using a general visible or near infrared spectrometer, by using air as a reference.

In addition, a polarized state of light at each wavelength can be measured using a spectral radiance meter or a spectrometer mounted on a circularly polarizing plate. In this case, the intensity of light measured through a right circularly polarizing plate corresponds to I_{R} and the intensity of light measured through a left circularly polarizing plate corresponds to I_{L}. In addition, general light sources such as a light bulb, a mercury lamp, a fluorescent light bulb, or an LED emit substantially natural light, and properties for generating polarized light of a polarized light state control member can be, for example, measured using a polarization phase difference analysis device AxoScan manufactured by Axometrics, Inc. by mounting this on the light sources.

The measurement can also be performed by attaching the circularly polarizing plate to an illuminometer or a light spectrometer. A ratio can be measured by measuring the right circularly polarized light intensity by attaching a right circularly polarizing transmission plate and measuring the left circularly polarized light intensity by attaching a left circularly polarizing transmission plate.

(Sensing of Target Object)

Light in a wavelength range of infrared light, particularly, near infrared light is used, as the light when sensing a target object of the sensing system or the sensing method of the invention. Polarized light may be used as the infrared light. By using the polarized light as the infrared light for performing the sensing, it is possible to apply optical properties of the target object in comparison with the background, in the sensing of reflected light and transmitted light from the target object through a film having selectivity for a transmitting property of the polarized light, the sensing of a target object having specific optical properties can be performed, and sensing with fewer operational errors can be performed. In addition, in this specification, an expression of “the reflected light and the transmitted light” is used to include scattered light and diffracted light. Further, circularly polarized light is used as the polarized light for performing the sensing in the sensing system or the sensing method of the invention. When the reflected light and the transmitted light from the target object are sensed using the circularly polarized light, a direction of a film for the polarized light detection is easily adjusted, compared to a case of using linearly polarized light as the polarized light.

As examples of the target object which can be used for the sensing by the sensing system or the sensing method of the invention, a transparent (birefringence) film or cracks or scratches on a specular reflector (metal plate or the like), or foreign material on a specular reflector may be used. In security applications, a person such as a pedestrian at night or a motion sensor used in an automatic door or an elevator is also used.

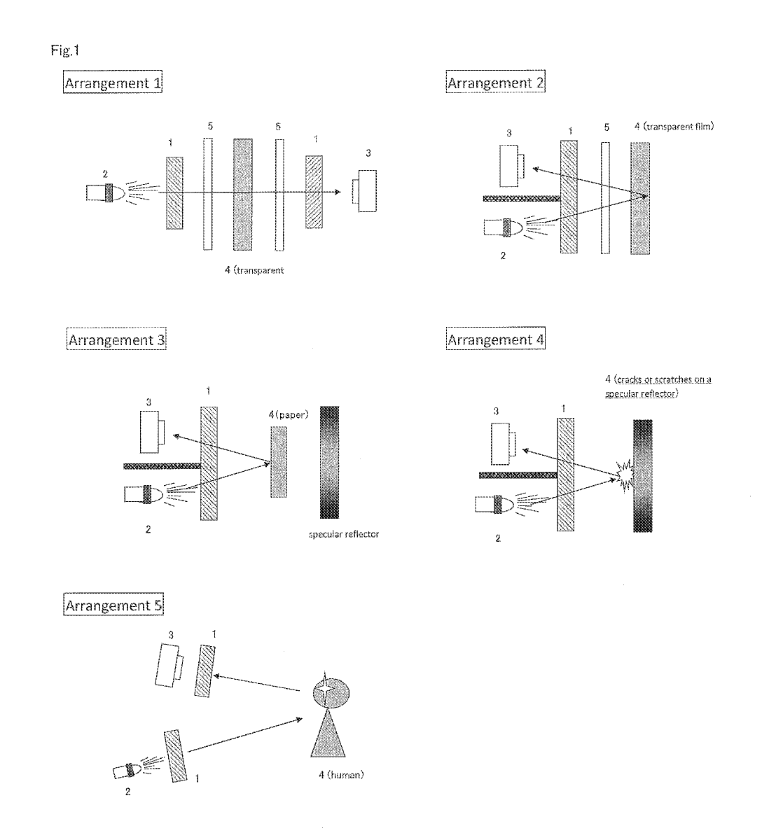

FIG. 1 shows arrangement examples of a light source, a light receiving element, and a circularly polarized light separation film for sensing the target object.

In an arrangement 1, a light source, a circularly polarized light separation film on a light source side (in this specification, may be referred to as a circularly polarized light separation film 1), a target object, a circularly polarized light separation film on a light receiving element side (in this specification, may be referred to as a circularly polarized light separation film 2), and a light receiving element are arranged in this order, and the transmitted light of the target object is sensed. A transparent film (particularly film having birefringence) is considered as the target object at that time. For example, in a production line of the film, this arrangement can be used for sensing light transmission of the film. In the arrangement 1, glass is respectively arranged between the target object and the circularly polarized light separation film 1 (1 in the drawing) and between the target object and the circularly polarized light separation film 2 (1 in the drawing), and an effect of the reflected light from the glass can be significantly decreased according to the usage of the circularly polarized light separation films.

In the arrangement 1, a visible light shielding layer may be included in the circularly polarized light separation film 2 or a film including a visible light shielding layer may be arranged between the circularly polarized light separation film 2 and the light receiving element. With such a configuration, it is possible to acquire high sensitivity regardless of the surrounding environment. When the circularly polarized light separation film 2 includes the visible light shielding layer, it is preferable that the visible light shielding layer is arranged on the light receiving element side and a circularly polarized light separation layer is arranged on the target object side. In addition, in the arrangement 1, the visible light shielding layer is preferably included in the circularly polarized light separation film 1 or a film including a visible light shielding layer is preferably arranged between the circularly polarized light separation film 1 and the light source. When the circularly polarized light separation film 1 includes the visible light shielding layer, it is preferable that the visible light shielding layer is arranged on the light source side and a circularly polarized light separation layer is arranged on the target object side.

Arrangements 2 to 4 have a configuration for sensing the reflected light and a configuration in which the circularly polarized light separation film 1 serves as the circularly polarized light separation film 2, that is, the circularly polarized light separation film 1 is the same as the circularly polarized light separation film 2. In the arrangements 2 to 4, the light source and the light receiving element are arranged on the same side surface side of the circularly polarized light separation film (1 in the drawing) as seen from the target object. In this configuration, as shown in the drawing, a layer which shields light may be provided between the light receiving element and the light source, so that the light receiving element is not affected by the direct light from the light source.

The arrangement 2 shows an example where a transparent layer (particularly film having birefringence) is the target object. Glass is arranged between the target object and the circularly polarized light separation film, and an effect of the reflected light from the glass can be significantly decreased according to the usage of the circularly polarized light separation film.

In the arrangement 3, a sheet on a specular reflector is sensed. This example is acquired by using a fact that, since the light which is circularly polarized through any one sense of the circularly polarized light separation film (1 in the drawing) is reflected as circularly polarized light of the other sense in the specular reflector, the light cannot approach the light receiving element through the circularly polarized light separation film, but the light diffusively reflected by the sheet includes a light component which can be transmitted through the circularly polarized light separation film.

The arrangement 4 shows an example of sensing foreign materials or cracks on the specular reflector as the target object, and the sensing principle is the same as that of the arrangement 3.

The arrangement 5 shows a configuration of sensing the reflected light and is an example using another film for the circularly polarized light separation film 1 and the circularly polarized light separation film 2. In the example of use, the light source (2 in the drawing) and the circularly polarized light separation film 1 (1 in the drawing) may be integrated and configure a light source device, or the light receiving element (3 in the drawing) and the circularly polarized light separation film 2 (1 in the drawing) may be integrated and configure an infrared sensor. In the example shown in the drawing, a person is sensed in the arrangement 5. For example, a pedestrian at night or a person in an elevator can be preferably sensed in such an arrangement.

In the arrangements 2 to 4, a visible light shielding layer may be included in the circularly polarized light separation film or a film including a visible light shielding layer may be arranged between the circularly polarized light separation film, and the light source and the light receiving element. With such a configuration, it is possible to acquire high sensitivity regardless of the surrounding environment. When the circularly polarized light separation film includes the visible light shielding layer, it is preferable that the visible light shielding layer of the circularly polarized light separation film is arranged on the light source and the light receiving element side and a circularly polarized light separation layer is arranged on the target object side.

In the arrangement 5, a visible light shielding layer may be included in the circularly polarized light separation film 2 or a film including a visible light shielding layer may be arranged between the circularly polarized light separation film 2 and the light receiving element. With such a configuration, it is possible to acquire high sensitivity regardless of the surrounding environment. When the circularly polarized light separation film 2 includes the visible light shielding layer, it is preferable that the visible light shielding layer of the circularly polarized light separation film 2 is arranged on the light receiving element side and a circularly polarized light separation layer side is arranged on the target object side. In addition, in the arrangement 5, the visible light shielding layer is also preferably included in the circularly polarized light separation film 1 or a film including a visible light shielding layer is preferably arranged between the circularly polarized light separation film 1 and the light source. When the circularly polarized light separation film 1 includes the visible light shielding layer, it is preferable that the visible light shielding layer is arranged on the light source side and a circularly polarized light separation layer is arranged on the target object side.

For example, as shown in the arrangements 2 to 5, it is preferable that an optical path (optical axis) of the reflected light or the transmitted light of the target object derived from the light source forms a right angle with the normal direction of the circularly polarized light separation film 2. For example, an angle of the optical path (optical axis) of the light with respect to the circularly polarized light separation film 2 may be from 70° to 89°, from 80° to 89°, or approximately 85°. With such arrangements, it is possible to decrease the sensing of light not derived from the target object which is acquired when the circularly polarized light reflected by the circularly polarized light separation film 2 is reflected again by the background, after the light is reflected by or transmitted through the specular reflector which is the background with respect to the target object, for example.

(Optical Properties of Circularly Polarized Light Separation Film)

The circularly polarized light separation film is a film which selectively allows the transmission of any one of right circularly polarized light and left circularly polarized light in at least a part of the near infrared light wavelength range. It is preferable that the circularly polarized light separation film separates light (natural light or unpolarized light) in a specific near infrared light wavelength range which is incident from one side surface into right circularly polarized light and left circularly polarized light and selectively allows the transmission of any one thereof to the other side surface. At that time, the other circularly polarized light may be reflected or absorbed.

The circularly polarized light separation film may selectively allow the transmission of any one of right circularly polarized light and left circularly polarized light with respect to the light incident from any surface, or may selectively allow the transmission of any one of right circularly polarized light and left circularly polarized light with respect to only the light incident from one surface and may not allow the same selective transmission with respect to the light incident from the other side surface. When using the latter case, the arrangement for acquiring desirable circularly polarized light selectivity may be used. In addition, the circularly polarized light separation film may separate light incident from any surface into right circularly polarized light and left circularly polarized light and selectively allow the transmission of any one thereof to the other side surface, or may separate only the light incident from any one surface into right circularly polarized light and left circularly polarized light, selectively allow the transmission of any one thereof to the other side surface, and may not allow the circularly polarized light separation with respect to the light incident from the other side surface. When using the latter case, the arrangement for acquiring desirable circularly polarized light selectivity may be used.

Regarding the circularly polarized light separation film, light transmittance {(light intensity of transmitted circularly polarized light)/(light intensity of incident circularly polarized light)×100} of the circularly polarized light having the same sense as the incidence ray when any one of the right circularly polarized light and left circularly polarized light in a range having a width equal to or greater than 50 nm from the range of a wavelength of 800 nm to 1500 nm is incident, may be 70% or more, 80% or more, 90% or more, 95% or more, 99% or more, or substantially preferably 100%. At that time, light transmittance {(light intensity of transmitted circularly polarized light)/(light intensity of incident circularly polarized light)×100} of the circularly polarized light having the same sense as the incidence ray when the circularly polarized light having the other sense is incident in the same wavelength range described above, may be 30% or less, 20% or less, 10% or less, 5% or less, 1% or less, or substantially preferably 0%.

The circularly polarized light separation film preferably has low light transmittance in the visible light wavelength range. Particularly, the circularly polarized light separation film 2 used on the light receiving element side preferably has low light transmittance in the visible light wavelength range. In addition, particularly, the circularly polarized light separation film used in a system or a method in which no additional film including a visible light shielding layer is used as described above, preferably has low light transmittance in the visible light wavelength range. In general, the transmittance of natural light (unpolarized light) may be low and the transmittance of circularly polarized light and/or linearly polarized light is also preferably low. In addition, the transmittance of light in a part of the visible light wavelength range may be low and the transmittance of light in the entire visible light wavelength range may be low. Specifically, the average light transmittance in a wavelength range of 380 nm to 780 nm may be 50% or less, 40% or less, 30% or less, 20% or less, 10% or less, or 5% or less.

When the transmittance of light in the visible light wavelength range is low, it is possible to significantly decrease light (light disturbing the sensing) which approaches the light emitting element and is unnecessary for the sensing in the system utilizing the circularly polarized light separation film, and it is possible to increase an S/N ratio and to decrease the minimum light intensity detected by the light receiving element.

The circularly polarized light separation film includes a circularly polarized light separation layer which selectively allows the transmission of any one of right circularly polarized light and left circularly polarized light in at least a part of the near infrared light wavelength range. The circularly polarized light separation film preferably includes a visible light shielding layer which reflects or absorbs light in at least a part of the visible light wavelength range. The circularly polarized light separation film including the visible light shielding layer is preferably used in a system or a method in which no additional film including the visible light shielding layer is used. The circularly polarized light separation film may include other layers, if necessary.

In the sensing system or the sensing method, the circularly polarized light separation film 2 may include the visible light shielding layer which reflects or absorbs light in at least a part the visible light wavelength range, or may be used with a film including the visible light shielding layer which reflects or absorbs light in at least a part the visible light wavelength range. The circularly polarized light separation film 1 used on the light source side preferably includes the visible light shielding layer which reflects or absorbs light in at least a part the visible light wavelength range, or is preferably used with a film including the visible light shielding layer which reflects or absorbs light in at least a part the visible light wavelength range. In addition, in this specification, the visible light shielding layer used on the light source side may be referred to as a visible light shielding layer 1 and the visible light shielding layer used on the light receiving element side may be referred to as a visible light shielding layer 2. Hereinafter, each layer will be described.

(Visible Light Shielding Layer)

The visible light shielding layer functions to prevent the transmission of light in a specific visible light wavelength range through the film. The visible light shielding layer preferably shields natural light. In addition, the visible light shielding layer preferably shields all of unpolarized light, circularly polarized light, and linearly polarized light. The circularly polarized light separation film may achieve a low light transmittance in the visible light wavelength range mainly by use of the visible light shielding layer.

As an example of the visible light shielding layer, a visible light reflection layer and a visible light absorption layer are used.

At least a part of the visible light wavelength range in which the visible light shielding layer shields the light by reflection or absorption may be a wavelength range of 380 nm to 780 nm. A wavelength bandwidth in at least a part of the visible light wavelength range may be equal to or greater than 10 nm, equal to or greater than 20 nm, equal to or greater than 30 nm, equal to or greater than 40 nm, or equal to or greater than 50 nm. The visible light wavelength range in which light is reflected by or absorbed by the visible light shielding layer preferably includes a wavelength range in which light (light disturbing the sensing) unnecessary for the sensing in the sensor (light receiving element) is easily detected. In addition, the visible light wavelength range preferably also includes a wavelength range of light other than a desired near infrared light wavelength range determined according to an emission wavelength from the light source. At least a part of the visible light wavelength range may be 50% or more; 60% or more, 70% or more, 80% or more, or 90% or more of the wavelength range of 380 nm to 750 nm, and substantially 100% thereof.

The visible light shielding layer may have a high light shielding property such as light reflectivity or light absorbability in at least a part of a wavelength range excluding a detection wavelength range of the sensor (light receiving element) used. Alternatively, the visible light shielding layer may have a high light shielding property in at least a part of a wavelength range excluding an emission wavelength range of a light source used which is generally an infrared light source. Since a silicon photodiode which is generally used as the light receiving element (photodetector) has sensitivity to the visible light region in which most light present in a usage environment exists and causes noise, the visible light shielding layer preferably performs the light reflection or light absorption with a focus on the visible light region. In addition, it is preferable that the visible light shielding layer substantially does not reflect or absorb light in the near infrared light wavelength range in which the circularly polarized light separation layer selectively allows the transmission of any one of right circularly polarized light and left circularly polarized light.

A thickness of the visible light shielding layer is preferably from 2 μm to 500 μm, more preferably from 5 μm to 300 μm, and even more preferably from 10 μm to 150 μm.

Hereinafter, the visible light reflection layer and the visible light absorption layer which can be used as the visible light shielding layer will be described, respectively.

(Visible Light Reflection. Layer)

With use of the visible light reflection layer which shields light by reflecting light there is no increase in temperature of the film, durability of the film is higher and film performance is easily maintained. In addition, the visible light reflection layer generally has a glass-like appearance and has a favorable influence on the appearance of the film, and accordingly; it is easy to use the the visible light reflection layer in a portion which is visible to a person, in a case where the visible light reflection layer is used as a sensor component.

As an example of the visible light reflection layer, a dielectric multilayer film and a layer obtained by fixing a cholesteric liquid-crystalline phase are used.

(Dielectric Multilayer Film)

The dielectric multilayer film which is a transparent dielectric is obtained by laminating a plurality of layers of inorganic oxide or an organic polymer material having different refractive indexes. Regarding at least any one layer of the transparent dielectric layers, the product (n×d) of a thickness (d) and a refractive index (n) of the transparent dielectric layer is set to be ¼ of a wavelength (λ) of the light to be reflected, a center wavelength of the reflection is λ, and the light in a range of a bandwidth of the reflection determined according to a difference between the refractive indexes of the dielectric layers can be reflected. In combination of general materials, it is difficult to reflect the entire visible light region by the dielectric multilayer film in one period, and accordingly, it is possible to perform the adjustment of enlarging the bandwidth of the reflection by laminating several layers having different center wavelengths of the reflected light by changing the value of n×d. The transparent dielectric layer is not particularly limited, as long as it has a transmitting property in the infrared light wavelength range used.

In general, as the inorganic oxides in the dielectric multilayer film, TiO₂, SiO₂, or Ta₂O₅ can be preferably used. A layer of the inorganic oxide can be, for example, formed on a surface of glass or a heat resistant polymer film by a sputtering method. Meanwhile, as an example of the inorganic polymer material, polycarbonate, an acrylic resin, polyester, an epoxy resin, polyurethane, polyamide, polyolefin, or silicone (including modified silicone such as silicone polyurea) is used, and the inorganic polymer material can be manufactured based on a method disclosed in JP1997-507308A (JP-H09-507308A).

(Layer Obtained by Fixing Cholesteric Liquid-Crystalline Phase: Visible Light Reflection Layer)

It is known that a cholesteric liquid-crystalline phase exhibits circularly polarized light selective reflection of selectively reflecting any one of right circularly polarized light and left circularly polarized light and transmitting other circularly polarized light. A number of cholesteric liquid-crystalline compounds or films formed from a cholesteric liquid-crystalline compound showing circularly polarized light selective reflection are known in the related art, and when using a layer obtained by fixing the cholesteric liquid-crystalline phase in the circularly polarized light separation film, the technologies of the related art can be referred to.

The layer obtained by fixing the cholesteric liquid-crystalline phase may be a layer in which orientation of liquid crystal compounds to be the cholesteric liquid-crystalline phases is maintained, and typically, a layer obtained by setting a polymerizable liquid crystal compound to have an orientation state of a cholesteric liquid-crystalline phase, polymerizing and hardening the compound by ultraviolet light irradiation and heating to form a layer having no fluidity, and at the same time, changing the state of the compound to a state where the orientation state is not changed by an external field or an external force. In addition, in the layer obtained by fixing the cholesteric liquid-crystalline phase, it is sufficient as long as optical properties of the cholesteric liquid-crystalline phase are maintained in the layer, and the liquid crystal compound in the layer may not show liquid crystalline properties. For example, the polymerizable liquid crystal compound may be polymerized by a curing reaction and lose liquid crystalline properties.

In this specification, the layer obtained by fixing the cholesteric liquid-crystalline phase may be referred to as a cholesteric liquid-crystalline layer or a liquid crystal layer.

The layer obtained by fixing the cholesteric liquid-crystalline phase exhibits circularly polarized light reflection derived from a helical structure of the cholesteric liquid crystal. A center wavelength λ of this reflection is present at intervals of a pitch length P (=period of helix) of the helical structure of the cholesteric phase, and satisfies a relationship of λ=n×p with respect to the average refractive index n of the cholesteric liquid-crystalline layer. Accordingly, it is possible to adjust the wavelength showing the circularly polarized light reflection by adjusting the pitch length of the helical structure. That is, in order to form the visible light reflection layer which reflects light in at least a part of the visible light wavelength range, the n value and the P value may be adjusted to set the center wavelength in a wavelength range of 380 nm to 780 nm. Since the pitch length of the cholesteric liquid crystal is dependent on the types of a chiral agent used with the polymerizable liquid crystal compound or added concentration thereof, a desirable pitch length can be obtained by adjusting these. As a measuring method of the sense or pitch of the helix, methods disclosed in “Introduction: Liquid Crystal Experiments” (edited by the Japanese Liquid Crystal Society, Sigma Publications, published in 2007 p. 46) and “Liquid Crystal Handbook” (Liquid Crystal Handbook Editorial Committee, Maruzen Publishing, p. 196) can be used.

In addition, the sense of the reflected circularly polarized light of the cholesteric liquid-crystalline layer coincides with the sense of the helix.

The reflectance at a reflection wavelength increases as as the cholesteric liquid-crystalline layer becomes thicker, but in a general liquid crystal material in general, saturation is obtained with a thickness of 2 to 8 μm in the wavelength range of visible light, and the reflection occurs with respect to only the circularly polarized light on one side, and accordingly, the reflectance is 50% at most. In order to perform the light reflection regardless of the sense of the circularly polarized light and to set the reflectance of natural light to be equal to or greater than 50%, as the visible light reflection layer, a laminate in which a cholesteric liquid-crystalline layer having right sense of helix and a cholesteric liquid-crystalline layer having left sense having the same period P, are laminated, or a laminate formed of cholesteric liquid-crystalline layers having the same period P and the same sense of helix, and a phase difference film having a phase difference of a half wavelength with respect to the center wavelength of the circularly polarized light reflection of the cholesteric liquid-crystalline layer disposed therebetween.

In addition, regarding the half-wavelength of the selective reflection (circularly polarized light reflection) range, Δλ is dependent on a birefringence Δn of the liquid crystal compound and the pitch length P and satisfies a relationship of Δλ=Δn×P. Accordingly, the width of the selective reflection range can be controlled by adjusting Δn. The adjustment of Δn can be performed by adjusting the types of polymerizable liquid crystal compound or a mixing ratio thereof, or controlling a temperature at the time of orientation fixation.

Since the width of the circularly polarized light reflection wavelength range in the visible light region is from 50 nm to 100 nm with a material in general, it is possible to enlarge the bandwidth of the reflection by laminating several types of cholesteric liquid-crystalline layers having different center wavelengths of the reflected light due to changes in the period P. In addition, in one cholesteric liquid-crystalline layer, it is possible to enlarge the bandwidth of the reflection by gradually changing the period P with respect to a film thickness direction.

A specific manufacturing material and a manufacturing method of the cholesteric liquid-crystalline layer will be described later.

(Visible Light Absorption Layer)

As the visible light absorption layer, a layer formed by applying a dispersion obtained by dispersing a colorant such as a pigment or a dye in a solvent containing a dispersing agent and a binder or a monomer on a base material (preferably a material having a sufficient light-transmitting property in the infrared light wavelength range detected by the light receiving element), a layer obtained by directly dying a surface of a polymer base material using a dye, or a layer formed of a polymer material containing a dye can be used.

As the pigment, a pigment which does not absorb or scatter in the infrared wavelength range detected by the light receiving element is preferably used. Accordingly, cyan, magenta, yellow, and black ink for color printing requiring transparency or a pigment used in a red, green, or blue-colored filter of a liquid crystal display device or an organic LED display device can be preferably used. It is possible to form a layer which sufficiently absorbs all light in the visible light wavelength range by mixing pigments having different maximum wavelengths of absorption.

As the dye, a dye does not absorb in the infrared light wavelength range detected by the light receiving element and is stable with respect to visible light exposure is used. A general direct dye, an acid dye, a basic dye, a mordant dye, a disperse dye, or a reactive dye can be used. As a dye type absorption layer, commercially available filters for photo filters IR-80, IR-82, or IR-84 (manufactured by Fujifilm Holdings Corporation) can be used.

(Circularly Polarized Light Separation Layer)

The circularly polarized light separation film includes the circularly polarized light separation layer which selectively allows the transmission of any one of right circularly polarized light and left circularly polarized light in at least a part of the near infrared light wavelength range. In addition, in this specification, the circularly polarized light separation layer used on the light source side may be referred to as a circularly polarized light separation layer 1 and the circularly polarized light separation layer used on the light receiving element side may be referred to as a circularly polarized light separation layer 2. The circularly polarized light separation film includes the circularly polarized light separation layer so that the function of the circularly polarized light separation layer of selectively allowing the transmission of any one of right circularly polarized light and left circularly polarized light is not lost due to other layers, and accordingly, the circularly polarized light separation film has a function of selectively allowing the transmission of any one of right circularly polarized light and left circularly polarized light at least in a part of the near infrared light wavelength range. That is, for example, the circularly polarized light separation film includes the circularly polarized light separation layer which selectively allows the transmission of any one of right circularly polarized light and left circularly polarized light in a specific near infrared light wavelength range and the circularly polarized light separation layer which reflects circularly polarized light beams having the same sense in the same wavelength range at the same time, or includes a layer which reflects or absorbs light (natural light), in the corresponding near infrared light wavelength range, and accordingly, it is preferable that the function of each circularly polarized light separation layer which selectively allows the transmission of any one of right circularly polarized light and left circularly polarized light is not offset.

The near infrared light wavelength range in which the circularly polarized light separation layer selectively allows the transmission of any one of right circularly polarized light and left circularly polarized light is from 780 nm to 1500 nm and preferably from 800 nm to 1500 nm, and the wavelength bandwidth thereof may be equal to or greater than 5 nm, equal to or greater than 10 nm, equal to or greater than 20 nm, equal to or greater than 30 nm, equal to or greater than 40 nm, or equal to or greater than 50 nm. The near infrared light wavelength range in which the circularly polarized light separation layer selectively allows the transmission of any one of right circularly polarized light and left circularly polarized light may include wavelengths of light necessary for the sensing, for example, in accordance with the usage state of the circularly polarized light separation film, and may be 50% or more, 60% or more, 70% or more, 80% or more, or 90% or more of the wavelength range of 800 nm to 1500 nm, and substantially 100% thereof.

The circularly polarized light separation layer may selectively allow the transmission, reflection, or absorption of light outside of the wavelength range in which any one of the right circularly polarized light and the left circularly polarized light is selectively transmitted. In addition, the circularly polarized light separation layer may selectively allow the transmission of any one of right circularly polarized light and left circularly polarized light, and may reflect or absorb the other circularly polarized light.

As the circularly polarized light separation layer, a layer obtained by fixing a cholesteric liquid-crystalline phase or a layer formed of a laminate including a linearly polarized light separation layer and a λ/4 phase difference layer can be used, for example.

(Layer Obtained by Fixing Cholesteric Liquid-Crystalline Phase: Circularly Polarized Light Separation Layer)

As the circularly polarized light separation layer, a layer obtained by fixing a cholesteric liquid-crystalline phase described above can be used. However, regarding the cholesteric liquid-crystalline layer used as the circularly polarized light separation layer, the center wavelength 2 may be set to be from 780 nm to 1500 nm and preferably from 800 nm to 1500 nm by adjusting the n value and the P value described above, so that any one of right circularly polarized light and left circularly polarized light is selectively transmitted (reflected) in at least a part of the near infrared light wavelength range.

As the circularly polarized light separation layer, a cholesteric liquid-crystalline layer having the sense of helix is right or left may be used, or when lamination is performed in order to increase circularly polarized light selectivity at a specific wavelength, a plurality of cholesteric liquid-crystalline layers having the same period P and the same sense of helix may be laminated. At that time, it is preferable to directly apply a liquid crystal composition including a polymerizable liquid crystal compound to the surface of a preexisting cholesteric liquid-crystalline layer which is formed by a method which will be described later, and repeating steps of orientation and fixation. By performing such steps, an orientation alignment of liquid crystal molecules on an air interface side of the cholesteric liquid-crystalline layer previously formed, and an orientation alignment of liquid crystal molecules on the lower side of the cholesteric liquid-crystalline layer formed thereon coincide with each other, and the light polarization properties of the circularly polarized light separation layer are improved.

In addition, in the same manner as in a case of using the cholesteric liquid-crystalline layer in the visible light reflection layer, a plurality of layers may be laminated in order to enlarge the selective reflection (transmission) wavelength bandwidth, but at that time, it is preferable to laminate the cholesteric liquid-crystalline layer having the same sense of helix.

The cholesteric liquid-crystalline layer can selectively allow the transmission of any one of right circularly polarized light and left circularly polarized light even with respect to light incident from any surface, and can separate even light incident from any surface into right circularly polarized light and left circularly polarized light and selectively allow the transmission of any one thereof to the other side surface.

A manufacturing material and a manufacturing method of the cholesteric liquid-crystalline layer will be described later.

(Laminate Including Linearly Polarized Light Separation Layer and λ/4 Phase Difference Layer)

In the circularly polarized light separation layer formed of the laminate including the linearly polarized light separation layer and the λ/4 phase difference layer, light emitted from the surface of the linearly polarized light separation layer is converted into linearly polarized light by reflection or absorption and then converted into right or left circularly polarized light by passing through the λ/4 phase difference layer. Meanwhile, in a case of light emission from the λ/4 phase difference layer, light in any polarized state becomes linearly polarized light by finally passing through the linearly polarized light separation layer, but specifically, in a case where the incidence ray is circularly polarized light, the light is converted into the linearly polarized light which is parallel to or orthogonal to a transmission axis of the linearly polarized light separation layer by the λ/4 phase difference layer, and accordingly, in order to use the light in recognition of the sense of the incident circularly polarized light, the light is preferably emitted from the λ/4 phase difference layer side, and when using the emitting circularly polarized light, the light is preferably emitted from the linearly polarized light separation layer side.

As the linearly polarized light separation layer, a linear polarizer can be used or a polarizer corresponding to the light in the infrared light range may be used.

(Linear Polarizer)

As the infrared linear polarizer which can be preferably used, a multilayer dielectric reflection polarizer in which a plurality of layers of resins having refractivity and different refractive indexes from each other are laminated and a thickness and a phase difference value are controlled by stretching, a grid polarizer configured with a number of parallel conductor line arrangements (grid), a polarizer in which metal nanoparticles having shape anisotropy are arranged and fixed, or a polarizer in which dichroic pigments are arranged and fixed, is used. All of these are easily formed in a thin layer shape, a film shape, or a plate shape, and can be formed by simply bonding a sheet-like phase difference layer which will be described later, in a step of forming the circularly polarized light separation layer. Alternatively, the phase difference layer can be formed by directly applying a composition for phase difference layer formation onto the infrared linear polarizer, and thus a thinner circularly polarized light separation layer can be manufactured.

The multilayer dielectric reflection polarizer is a polarizing film which transmits only the light in a vibration direction parallel to the plane transmission axis and reflects the other light. As such a film, a multilayer film disclosed in JP1997-507308A (JP-H09-507308A) can be used. This is obtained by alternatively laminating a layer formed of the transparent dielectric layer 1 not having birefringence in the film surface and a layer formed of the transparent dielectric layer 2 having birefringence in a surface, and is formed so that a refractive index of the transparent dielectric layer 1 coincides with any one of an ordinary light refractive index and an extraordinary light refractive index of the transparent dielectric layer 2. In addition, at least any one of the transparent dielectric layers is configured so that the product (n×d) of the thickness (d) and the refractive index (ii) of the transparent dielectric layer becomes ¼ of the wavelength of the light to be reflected. The material for forming the transparent dielectric layers may be materials having light-transmitting properties at the infrared light wavelength used, and examples thereof include polycarbonate, an acrylic resin, polyester, an epoxy resin, polyurethane, polyamide, polyolefin, a cellulose derivative, or silicone (including modified silicone such as silicone polyurea).

The grid polarizer is obtained by providing a plurality of parallel conductor line arrangement structures (grids) having a submicron pitch (pitch shorter than the wavelength of the incidence ray) formed of a good conductor thin film such as aluminum, silver, or gold, on one surface of a polymer film having light-transmitting properties at the infrared light wavelength used, a glass substrate or a silicon (Si) substrate, and a polarizer disclosed in JP2002-328234A can be used. This polarizer functions as a polarizer by reflecting the polarized light component parallel to a grid in the incidence rayand transmitting the polarized light component orthogonal thereto. If necessary, this can be interposed between the glass or an anti-reflection layer can be provided.

The polarizer in which metal nanoparticles having shape anisotropy are arranged and fixed is obtained by orienting and fixing silver halide particles or silver particles having a great aspect ratio. This polarizer is an absorption type linear polarizing plate which absorbs infrared light having an electric field vibration surface in the arrangement direction of the particles and transmits the infrared light in a direction orthogonal thereto. As an example thereof, polarizing plates disclosed in JP1984-83951A (JP-S59-83951A), JP1990-248341A (JP-H02-248341A), and JP2003-139951A can be used.

As the polarizer in which dichroic pigments are arranged and fixed, an infrared polarizing film in which iodine is adsorbed or dichroic dye is doped in PVA (polyvinyl alcohol) and stretched to make polyvinylene can be used. This polarizer absorbs the infrared light having an electric field vibration surface in the stretching direction and transmits the infrared light in the direction orthogonal thereto.

This can obtain the orientation of dichroic pigments by performing dyeing of a PVA layer by passing through the PVA film in a dye composition tank of iodine/iodide and stretching the layer by a factor of 4 to 6 times. The conversion of PVA to polyvinylene can be performed by a hydrochloric acid vapor method disclosed in U.S. Pat. No. 2,445,555A. In addition, in order to improve stability of the materials for polarization, boration of the material into is also performed by using an aqueous borate bath containing boric acid and borax. A commercially available near infrared linear polarizing film manufactured by Edmund Optics Japan can be used as a product corresponding thereto.

The thickness of the linearly polarized light separation layer is preferably from 0.05 μm to 300 μm, more preferably from 0.2 μm to 150 μm, and even more preferably from 0.5 μm to 100 μm.

(λ/4 Phase Difference Layer)

An inplane slow axis of a phase difference plate is present at an alignment rotated by 45° from the absorption axis or the transmission axis of the polarizing plate. When a single light source such as an LED or a laser is used as the infrared light source, the front surface phase difference of the phase difference plate is desirably a length of ¼ of the center wavelength of the emission wavelength of the light source or “center wavelength*n±¼ of center wavelength (n is an integer)”, and for example, when the emission center wavelength of the light source is 1000 nm, the phase difference of 250 nm, 750 nm, 1250 nm, or 1750 nm is preferable. In addition, small dependency of the phase difference on the light incident angle is preferable, and a phase difference plate having a phase difference of a length of ¼ of the center wavelength is most preferable from this viewpoint.

In the sensing system or the sensing method of the invention, when various types of light source having different emission wavelengths are used in combination as the infrared light source, or a light source in which there is a peak in the light emission intensity at greater than or equal to two wavelengths or a light source in which the light emission is performed in a wide wavelength range is used, a case of enlarging the wavelength range showing the circularly polarized light selectivity is considered, Even in such a case, the phase difference plate described above can be used, but it is more preferably to use a phase difference plate having a wide range. A phase difference plate having a wide range is a phase difference plate in which a phase difference angle is constant over the wide wavelength range, and examples thereof include a laminated phase difference plate in which phase difference layers having different wavelength dispersions of the birefringence from each other are set to be orthogonal to the slow axis thereof to have a wide range, a polymer film in which substituents having different wavelength dispersions of the birefringence from each other are set to be orthogonal to an arrangement axis thereof using the principle described above at a molecular level to perform the orientation formation, or a phase difference plate in which a layer of λ/2 which is the phase difference with respect to the wavelength (λ) in the wavelength range used and a layer of λ/4 are laminated by being caused to intersect the slow axis thereof at 60 degrees.

Examples of the material of the phase difference plate include crystalline glass or crystal of an inorganic material, a polymer such as polycarbonate, an acrylic resin, polyester, an epoxy resin, polyurethane, polyamide, polyolefin, a cellulose derivative, or silicone (including modified silicone such as silicone polyurea), or a material in which polymerizable liquid crystal compounds or polymer liquid crystal compounds are arranged and fixed.

The thickness of the λ/4 layer is preferably from 0.2 μm to 300 μm, more preferably from 0.5 μm to 150 μm, and even more preferably from 1 μm to 80 μm.

(Manufacturing Method of Layer Obtained by Fixing Cholesteric Liquid-Crystalline Phase)

Hereinafter, manufacturing materials and a manufacturing method of the cholesteric liquid-crystalline layer which can be used in the visible light reflection layer or the circularly polarized light separation layer will be described.

As the materials used for the formation of the cholesteric liquid-crystalline layer, a liquid crystal composition containing the polymerizable liquid crystal compound and the chiral agent (optically active compound) are used. If necessary, a liquid crystal composition obtained by additionally mixing in a surfactant or a polymerization initiator and dissolving the mixture in a solution is applied to the base material (a support, an oriented film, or the cholesteric liquid-crystalline layer as a lower layer), cholesteric orientation and aging is performed, and fixed to form the cholesteric liquid-crystalline layer.

Polymerizable Liquid Crystal Compound

The polymerizable liquid crystal compound may be a rod-like liquid crystal compound or a disk-like liquid crystal compound, and a rod-like liquid crystal compound is preferably used.

As an example of a rod-like polymerizable liquid crystal compound for forming the cholesteric liquid-crystalline layer, a rod-like nematic liquid crystal compound may be used. As a rod-like nematic liquid crystal compound, azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, and alkenylcyclohexylbenzonitriles are preferably used. Not only a low-molecular-weight liquid crystal compound, but also a high-molecular-weight liquid crystal compound can be used.

A polymerizable cholesteric liquid-crystalline compound is obtained by introducing a polymerizable group to the cholesteric liquid-crystalline compound. Examples of the polymerizable group include an unsaturated coincidence group, an epoxy group, and an aziridinyl group, an unsaturated polymerizable group is preferable and an ethylenically unsaturated polymerizable group is particularly preferable. The polymerizable group can be introduced into molecules of the cholesteric liquid-crystalline compound by various methods. The number of polymerizable groups included by the polymerizable cholesteric liquid-crystalline compound is preferably from 1 to 6 and more preferably from 1 to 3. Examples of the polymerizable cholesteric liquid-crystalline compound include compounds disclosed in Makromol. Chem., vol. 190, 2255 p, (1989), Advanced Materials, vol. 5, 107 p (1993), U.S. Pat. No. 4,683,327A, U.S. Pat. No. 5,622,648A, U.S. Pat. No. 5,770,107 A, WO95/22586A, WO95/24455A, WO97/00600A, WO98/23580A, WO98/52905A, JP1989-272551A (JP-H01-272551A), JP1994-16616A (JP-H06-16616A), JP1995-110469A (JP-H07-110469A), JP1999-80081A (JP-H11-80081), and JP2001-328973A. Two or more types of polymerizable cholesteric liquid-crystalline compound may be used in combination. When two or more types of polymerizable cholesteric liquid-crystalline compound are used in combination, it is possible to decrease the orientation temperature.

In addition, the added amount of the polymerizable liquid crystal compound in the liquid crystal composition is preferably from 10% by mass to 60% by mass, more preferably from 20% by mass to 50% by mass, and particularly preferably from 30% by mass to 40% by mass, with respect to the solid content mass (mass excluding the solvent) of the liquid crystal composition.

Chiral Agent (Optically Active Compound)

The chiral agent has a function of causing the helical structure of the cholesteric liquid-crystalline phase. Since the sense of helix or the helical pitch varies according to the compound, the chiral compound may be selected according to the purpose.

The chiral agent is not particularly limited, and well-known compounds (for example, Liquid Crystal Device Handbook, third vol. paragraphs 4-3, a chiral agent for TN or STN, p. 199, Japan Society for the Promotion of Science 142th Committee Edition, 1989), isosorbide, or an isomannide derivative can be used.

The chiral agent generally includes asymmetric carbon atoms, but an axial asymmetric compound or a planar asymmetric compound not including asymmetric carbon atoms can be used as the chiral agent. As an example of an axial asymmetric compound or a planar asymmetric compound, binaphthyl, helicene, paracyclophane, and derivatives thereof are included. The chiral agent may include a polymerizable group. When the chiral agent and a curable cholesteric liquid-crystalline compound include a polymerizable group, it is possible to form a polymer including a repeating unit derived from the cholesteric liquid-crystalline compound and a repeating unit derived from the chiral agent, by the polymerization reaction between the polymerizable chiral agent and the polymerizable cholesteric liquid-crystalline compound. In this state, the polymerizable group included in the polymerizable chiral agent is preferably the same type of group as the polymerizable group included in the polymerizable cholesteric liquid-crystalline compound. Accordingly, the polymerizable group of the chiral agent is preferably an unsaturated polymerizable group, an epoxy group, or an aziridinyl group, more preferably an unsaturated polymerizable group, and particularly preferably an ethylenically unsaturated polymerizable group.

In addition, the chiral agent may be a liquid crystal compound.

It is preferable that the chiral agent includes a photoisomerizing group, because it is possible to form with a pattern of a desirable reflection wavelength corresponding to the emission wavelength by photo mask exposure using an active light after the application and orientation. As a photoisomerizing group, an isomerization site in a compound exhibiting a photochromic properties, azo, azoxy, and cinnamoyl group are preferable. Specific examples of the compound can include compounds disclosed in JP2002-80478A, JP2002-80851A, JP2002-179668A, JP2002-179669A, JP2002-179670A, JP2002-179681A, JP2002-179682A, JP2002-338575A, JP2002-338668A, JP2003-313189A, and JP2003-313292A.

The content of the chiral agent in the liquid crystal composition is preferably from 0.01% mol to 200% mol and more preferably from 1% mol to 30% mol of the amount of the polymerizable liquid crystal compound.

Polymerization Initiator

The liquid crystal composition preferably contains a polymerization initiator. In a case of causing the polymerization reaction to proceed using the ultraviolet light irradiation, the polymerization initiator used is preferably a photopolymerization initiator which can start the polymerization reaction by an ultraviolet light irradiation. Examples of the photopolymerization initiator include an α-carbonyl compound (disclosed in each specification of U.S. Pat. No. 2,367,661A and U.S. Pat. No. 2,367,670A), acyloin ether (disclosed in the specification of U.S. Pat. No. 2,448,828A), a α-hydrocarbon-substituted aromatic acyloin compound (disclosed in the specification of U.S. Pat. No. 2,722,512A), a polynuclear quinone compound (disclosed in each specification of U.S. Pat. No. 3,046,127A and U.S. Pat. No. 2,951,758), a combination of a triaryl imidazole dimer and p-amino phenyl ketone (disclosed in the specification of U.S. Pat. No. 3,549,367A), acridine and phenazine compounds (disclosed in each specification of JP1985-105667A (JP-S60-105667A) and U.S. Pat. No. 4,239,850A), and an oxadiazole compound (disclosed in the specification of U.S. Pat. No. 4,212,970A).

The content of the photopolymerization initiator in the liquid crystal composition is preferably from 0.1% by mass to 20% by mass and more preferably from 0.5% by mass to 5% by mass, with respect to the content of the polymerizable liquid crystal compound.

Cross-Linking Agent

The liquid crystal composition may contain an arbitrary cross-linking agent, in order to improve film strength after the curing and durability. As the cross-linking agent, a material which is hardened by ultraviolet light, heat, or humidity can be preferably used.

The cross-linking agent is not particularly limited and can be suitably selected according to the purpose, and examples thereof include a multifunctional acrylate compound such as trimethylolpropane tri(meth)acrylate or pentaerythritol tri(meth)acrylate; an epoxy compound such as glycidyl (meth)acrylate or ethylene glycol diglycidyl ether; an aziridine compound such as 2,2-bishydroxymethylbutanol-tris[3-(1-aziridinyl)propionate] or 4,4-bis (ethylene iminocarbonyl amino)diphenylmethane; an isocyanate such as hexamethylene diisocyanate or biuret type isocyanate; a polyoxazoline compound including an oxazoline group as a side chain; and an alkoxysilane compound such as vinyltrimethoxysilane or N-(2-aminoethyl)-3-aminopropyltrimethoxysilane. In addition, a well-known catalyst can be used according to the reactivity of the cross-linking agent and it is possible to improve productivity, in addition to the film strength and durability. These may be used alone or in combination of two or more kinds thereof

The content of the cross-linking agent is preferably from 3% by mass to 20% by mass and more preferably from 5% by mass to 15% by mass. When the content of the cross-linking agent is smaller than 3% by mass, an effect of the improvement in crosslinking density may not be obtained, and when the content thereof exceeds 20% by mass, stability of the cholesteric layer may be lower.

Orientation Controlling Agent

An orientation controlling agent which contributes to stable and rapid formation of a planar orientation in a cholesteric liquid-crystalline layer may be added to the liquid crystal composition. Examples of the orientation controlling agent include a fluorine (meth)acrylate polymer disclosed in Paragraphs [0018] to [0043] of JP2007-272185A and compounds represented by Formulae (I) to (IV) disclosed in Paragraphs [0031] to [0034] of JP2012-203237A.

In addition, as the orientation controlling agent, these may be used alone or in combination of two or more kinds thereof.

The added amount of the orientation controlling agent in the liquid crystal composition is preferably from 0.01% by mass to 10% by mass, more preferably from 0.01% by mass to 5% by mass, and particularly preferably from 0.02% by mass to 1% by mass, with respect to the entire mass of the cholesteric liquid-crystalline compound.

Other Additives

Other liquid crystal compositions may contain at least one kind selected from various additives such as a surfactant for adjusting surface tension of a coated film to obtain an even film thickness, and a polymerizable monomer. Further, if necessary, a polymerization inhibitor, an antioxidant, an ultraviolet absorbing agent, a light stabilizer, a coloring material, and metal oxide fine particles can be added to the liquid crystal composition, in a range not decreasing the optical properties.

A cholesteric liquid-crystalline layer in which cholesteric regularity is fixed can be formed, by applying a liquid crystal composition obtained by dissolving the polymerizable liquid crystal compound and the polymerization initiator, and if necessary, the chiral agent and the surfactant in a solvent, on the base material, obtaining a dried coated film, and irradiating this coated film with active light to polymerize the cholesteric liquid-crystalline composition. In addition, a laminated film formed of a plurality of cholesteric layers can be formed by repeating the manufacturing step of the cholesteric layer.

The solvent used in the preparation of the liquid crystal composition is not particularly limited and can be suitably selected according to the purpose, and an organic solvent is preferably used.

The organic solvent is not particularly limited and can be suitably selected according to the purpose, and examples thereof include ketones, alkyl halides, amides, sulfoxides, heterocyclic compounds, hydrocarbons, esters, and ethers. These may be used alone or in combination of two or more kinds thereof. Among these, ketones are particularly preferable, when environmental load is considered.

A method of applying the liquid crystal composition to the base material is not particularly limited and can be suitably selected according to the purpose, and examples thereof include a wire bar coating method, a curtain coating method, an extrusion coating method, a direct gravure coating method, a reverse gravure coating method, a die coating method, a spin coating method, a dip coating method, a spray coating method, and a slide coating method. In addition, the application can be executed by transferring the liquid crystal composition applied to an additional support to the base material. The liquid crystal molecules are oriented by heating the applied liquid crystal composition. The heating temperature is preferably equal to or lower than 200° C. and more preferably equal to or lower than 130° C. By performing this orientation process, an optical thin film in which the polymerizable liquid crystal compound is twist-oriented so as to have a screw axis substantially orthogonal to a film surface is obtained.

The oriented liquid crystal compound may be further polymerized. The polymerization may be any of thermal polymerization and photopolymerization performed by light irradiation, and photopolymerization is preferable. The light irradiation is preferably performed using ultraviolet light. The irradiation energy is preferably from 20 mJ/cm² to 50 J/cm² and more preferably from 100 mJ/cm² to 1500 mJ/cm². In order to promote the photopolymerization reaction, the light irradiation may be executed under heating conditions or an nitrogen atmosphere. The emitted ultraviolet light wavelength is preferably from 350 nm to 430 nm. The polymerization reaction rate is preferably high, preferably equal to or greater than 70%, and more preferably equal to or greater than 80%, from a viewpoint of stability.

The polymerization reaction rate can be determined as the rate of consumption of the polymerizable functional group using an IR absorption spectrum.

In addition, the thickness (total of the plurality of layers, when the plurality of layers are laminated) of the cholesteric liquid-crystalline layer which is the circularly polarized light separation layer in the near infrared wavelength range is preferably from 1 μm to 150 μm, more preferably from 2 μm to 100 μm, and even more preferably from 5 μm to 50 μm.

(Other Layers)

The circularly polarized light separation film may include other layers such as a support, an orientation layer for causing the orientation of the liquid crystal compound, and an adhesion layer for adhering the circularly polarized light separation layer and the visible light shielding layer to each other. In addition, the film including the visible light shielding layer may also include other layers such as a support.

The support is not particularly limited and a plastic film or glass may be used. It is preferable that the support does not have a property of offsetting the optical properties of the visible light shielding layer or the circularly polarized light separation layer, and the support is generally transparent and preferably has low birefringence. Examples of the plastic film include polyester such as polyethylene terephthalate (PET), polycarbonate, an acrylic resin, an epoxy resin, polyurethane, polyamide, polyolefin, a cellulose derivative, and silicone. The support used for manufacturing the cholesteric liquid-crystalline layer may be peeled off from the circularly polarized light separation film.

The orientation film can be provided by means of rubbing treatment of an organic compound and a polymer (a resin such as polyimide, polyvinyl alcohol, polyester, polyarylate, polyamideimide, polyetherimide, polyamide, or modified polyamide), oblique evaporation of an inorganic material, formation of a layer having a microgroove, or accumulation of an organic compound (for example, ω-tricosanoic acid, dioctadecyl methyl ammonium chloride, or methyl stearate) by a Langmuir-Blodgett method (LB film). In addition, an orientation film which has an orientation function by applying an electric field, applying a magnetic field, or performing light irradiation is also known. Among these, the orientation film formed by the rubbing treatment of the polymer is particularly preferable. The rubbing treatment can be executed by rubbing the surface of the polymer layer in a given direction with paper or a fabric.

The liquid crystal composition may be applied to the surface of the support or the surface on which the rubbing treatment of the support is performed, without providing the orientation film.

An adhesive may be a hot melt type, a heat curing type, a photocuring type, a reactive curing type, and a pressure sensitive adhesion type which does not need curing from a viewpoint of the curing method, and as a material of each type, acrylate, urethane, urethane acrylate, epoxy, epoxy acrylate, polyolefin, modified olefin, polypropylene, ethylene vinyl alcohol, vinyl chloride, chloroprene rubber, cyanoacrylate, polyamide, polyimide, polystyrene, and polyvinyl butyral compounds can be used. The curing method is preferably the photocuring type, from the viewpoints of workability and productivity, and as the material, an acrylate, urethane acrylate, or epoxy acrylate compound is preferably used, from the viewpoints of optical transparency and heat resistance.

(Manufacturing Method of Circularly Polarized Light Separation Film Including Visible Light Shielding Layer)

The circularly polarized light separation film including the visible light shielding layer can be, for example, manufactured by bonding the visible light shielding layer and the circularly polarized light separation layer which can be manufactured as described above to each other using an adhesive or the like. The surface to be bonded is not particularly limited, and when the support is included, the surface may be the support surface side or the opposite side thereto. After bonding both layers described above, the support may be peeled off or may not be peeled off. When the circularly polarized light separation layer includes the linearly polarized light separation layer and the λ/4 phase difference layer, the visible light shielding layer is preferably bonded to the surface on the linearly polarized light separation layer, as seen from the λ/4 phase difference layer.

The circularly polarized light separation film including the visible light shielding layer may be manufactured by forming the circularly polarized light separation layer through a step of directly applying a composition for the circularly polarized light separation layer formation on the visible light shielding layer, or may be manufactured by forming the visible light shielding layer through a step of directly applying a composition for the visible light shielding layer formation on the circularly polarized light separation layer.

(Light Receiving Element and Infrared sensor)

As the light receiving element used in the sensing system or the sensing method, a photodiode type sensor using a semiconductor such as Si, Ge, HgCdTe, PtSi, InSb, or PbS, a detector in which light detecting elements are linearly arranged, or a CCD or a CMOS for acquiring an image is used.

In the sensing system or the sensing method, as a part of the infrared sensor, the circularly polarized light separation film may be used by being bonding to the light receiving element which can detect light at wavelengths which is one of the right circularly polarized light and the left circularly polarized light which is selectively allowed to be transmitted by the circularly polarized light separation film: For example, the circularly polarized light separation film can be disposed on the light receiving surface of the infrared sensor.

The infrared sensor preferably has a configuration in which the light receiving element is in a housing, the circularly polarized light separation film is arranged in a light receiving portion, and the light other than light passed through the circularly polarized light separation film does not approach the light receiving element. In addition, when the circularly polarized light separation film includes the visible light shielding layer, it is preferable that the circularly polarized light separation layer of the circularly polarized light separation film is disposed on the outer side and the visible light shielding layer is disposed on the light receiving element side. When the circularly polarized light separation layer includes the linearly polarized light separation layer and the λ/4 phase difference layer, it is preferable that the λ/4 phase difference layer is disposed on the outer side and the linearly polarized light separation layer is disposed on the light receiving element side. The film including the visible light shielding layer may be disposed in the light receiving portion with the circularly polarized light separation film In this case, it is preferable that the circularly polarized light separation film is disposed on the outer side and the film including the visible light shielding layer is disposed on the light receiving element side.

(Light Source and Light Source Device)

As the light source, any light source can be used as long as it emits light at a photosensitive wavelength of the light receiving element such as a halogen lamp, a tungsten lamp, an LED, an LD, a xenon lamp, or a metal halide lamp, and an LED or an LD are preferable, from the viewpoints of a small size, emission directivity, monochromatic light, and pulse modification ability. The light source is preferably a near infrared light source.

In the sensing system or the sensing method, the light source and the circularly polarized light separation film may be combined with each other to configure the light source device. The light source device preferably has, for example, a configuration in which the light source is included in a housing, the circularly polarized light separation film is arranged in a light emission portion, and the light other than light passing through the circularly polarized light separation film is not emitted from the light source. In addition, when the circularly polarized light separation film includes the visible light shielding layer, it is preferable that the circularly polarized light separation layer is disposed on the outer side and the visible light shielding layer is disposed on the light source side. When the circularly polarized light separation layer includes the linearly polarized light separation layer and the λ/4 phase difference layer, it is preferable that the λ/4 phase difference layer is disposed on the outer side and the linearly polarized light separation layer is disposed on the light source side. The film including the visible light shielding layer may be disposed in the light receiving portion with the circularly polarized light separation film. In this case, it is preferable that the circularly polarized light separation film is disposed on the outer side and the film including the visible light shielding layer is disposed on the light source side.

As will be described in Examples, the circularly polarized light separation film may be used separately from the infrared sensor and the light source device. In this case, the circularly polarized light separation film may be disposed and used between the target object and the light receiving element and/or between the target object and the light source. At that time, it is possible to adjust the direction of the film with respect to the target object based on the description regarding the infrared sensor or the light source described above.

### EXAMPLES

Hereinafter, the invention will be described in more detail with reference to Examples. The materials, the reagents, the amounts of materials, the proportions thereof, the operations, and the like can be suitably modified within a range not departing from a gist of the invention. Accordingly, the range of the invention is not limited to the following Examples.

### Example R1

### Preparation of Circularly Polarized Light Separation Layer

A coating solution A-2 shown in Table 1 was applied to a PET rubbing-treated surface which had been subjected to rubbing treatment and manufactured by Fujifilm Holdings Corporation using a wire bar at room temperature so that a thickness of a dry film after performing drying was 5 μm. After drying the coated layer for 30 seconds at room temperature, the coated layer was heated for 2 minutes in the atmosphere at 85° C. and UV-irradiated using a D bulb (lamp 90 mW/cm) manufactured by Fusion UV Inc., for 6 to 12 seconds with an output of 60% at 30° C., and a liquid crystal layer was obtained. A coating solution A-3 shown in Table 1 was applied onto this liquid crystal layer at the room temperature so that a thickness of a dry film after performing the drying was 5 μm, and the coated layer was dried, heated, and UV-irradiated in the same manner as described above, to form a liquid crystal layer as a second layer, and a circularly polarized light separation layer was obtained.

Preparation of Visible Light Reflection Layer

A coating solution B-1 shown in Table 2 was applied to a PET rubbing-treated surface which had been subjected to rubbing treatment and manufactured by Fujifilm Holdings Corporation using a wire bar at the room temperature so that a thickness of a dry film after performing the drying was 2 μm. After drying the coated layer for 30 seconds at the room temperature, the coated layer was heated for 2 minutes in the atmosphere at 85° C. and UV-irradiated using a D bulb (lamp 90 mW/em) manufactured by Fusion UV Inc., for 6 to 12 seconds with output of 60% at 30° C., and a liquid crystal layer was obtained. A coating solution B-2 shown in Table 2 was applied onto this liquid crystal layer at the room temperature so that a thickness of a dry film after performing the drying was 2 μm, and the coated layer was dried, heated, and UV-irradiated in the same manner as described above, to form a liquid crystal layer as a second layer. Liquid crystal layers as third to sixteenth layers were formed on the second liquid crystal layer, by the same step described above using each of coating solutions B-3 to B-16 shown in Table 2, and a visible light reflection layer was obtained.

Bonding of Visible Light Reflection Layer and Circularly Polarized Light Separation Layer

An UV curable adhesive Exp. U12034-6 manufactured by DIC Corporation was applied to the surface of the manufactured circularly polarized light separation layer on the light crystal layer side using a wire bar at the room temperature so that a thickness of a dry film after performing the drying was 5 μm. This coated surface and the surface of the visible light reflection layer on the liquid crystal layer side were bonded to each other so that air bubbles were not generated, and were UV-irradiated using a D bulb (lamp 90 mW/cm) manufactured by Fusion UV Inc., for 6 to 12 seconds with output of 60% at 30° C. Then, the PET manufactured by Fujifilm Holdings Corporation which was the support of the circularly polarized light separation layer and the visible light reflection layer was peeled off, and a circularly polarized light separation film of Example R1 was obtained.

### Example R2

A coating solution A-1 shown in Table 1 was applied to a PET rubbing-treated surface which is subjected to the rubbing treatment and manufactured by Fujifilm Holdings Corporation using a wire bar at a room temperature so that a thickness of a dry film after performing the drying was 5 μm. After drying the coated layer for 30 seconds at the room temperature, the coated layer was heated for 2 minutes in the atmosphere at 85° C. and UV-irradiated using a D bulb (lamp 90 mW/cm) manufactured by Fusion UV Inc., for 6 to 12 seconds with output of 60% at 30° C., and a liquid crystal layer was obtained. A coating solution A-2 shown in Table 1 was applied onto this liquid crystal layer at the room temperature so that a thickness of a dry film after performing the drying is 5 μm, and the coated layer was dried, heated, and UV-irradiated in the same manner as described above, to form a liquid crystal layer as a second layer. A coating solution A-3 shown in Table 1 was applied onto the second liquid crystal layer at the room temperature so that a thickness of a dry film after performing the drying is 5 μm, and the coated layer was dried, heated, and UV-irradiated in the same manner as described above, to form a liquid crystal layer as third layer, and a circularly polarized light separation layer was obtained.

The manufactured circularly polarized light separation layer was bonded to a visible light reflection layer which was the same visible light reflection layer as that manufactured in Example R1 by the same method as in Example R1, and a circularly polarized light separation film of Example R2 was obtained.

### Example R3

The coating solution A-1 shown in Table 1 was applied to a PET rubbing-treated surface which is subjected to the rubbing treatment and manufactured by Fujifilm Holdings Corporation using a wire bar at a room temperature so that a thickness of a dry film after performing the drying was 5 μm. After drying the coated layer for 30 seconds at the room temperature, the coated layer was heated for 2 minutes in the atmosphere at 85° C. and UV-irradiated using a D bulb (lamp 90 mW/cm) manufactured by Fusion UV Inc., for 6 to 12 seconds with output of 60% at 30° C., and a liquid crystal layer was obtained. The coating solution A-2 shown in Table 1 was applied onto this liquid crystal layer at the room temperature so that a thickness of a dry film after performing the drying was 5 μm, and the coated layer was dried, heated, and UV-irradiated in the same manner as described above, to form a liquid crystal layer as a second layer. Liquid crystal layers as third to ninth layers were formed on the second liquid crystal layer, by the same step described above using each of coating solutions A-3 to A-9 shown in Table 1, and a circularly polarized light separation layer was obtained.

The manufactured circularly polarized light separation layer was bonded to a visible light reflection layer which was the same visible light reflection layer manufactured in Example R1 by the same method as in Example R1, and a circularly polarized light separation film of Example R3 was obtained.

### Example R4

The coating solution A-1 shown in Table 1 was applied to a PET rubbing-treated surface which is subjected to the rubbing treatment and manufactured by Fujifilm Holdings Corporation using a wire bar at a room temperature so that a thickness of a dry film after performing the drying was 5 μm. After drying the coated layer for 30 seconds at the room temperature, the coated layer was heated for 2 minutes in the atmosphere at 85° C. and UV-irradiated using a D bulb (lamp 90 mW/cm) manufactured by. Fusion UV Inc., for 6 to 12 seconds with output of 60% at 30° C., and a liquid crystal layer was obtained. The coating solution A-2 shown in Table 1 was applied onto this liquid crystal layer at the room temperature so that a thickness of a dry film after performing the drying was 5 μm, and the coated layer was dried, heated, and UV-irradiated in the same manner as described above, to form a liquid crystal layer as a second layer. Liquid crystal layers as third to twelfth layers were formed on the second liquid crystal layer, by the same step described above using each of coating solutions A-3 to A-12 shown in Table 1, and a circularly polarized light separation layer was obtained.

The manufactured circularly polarized light separation layer was bonded to a visible light reflection layer which was the same visible light reflection layer manufactured in Example R1 by the same method as in Example R1, and a circularly polarized light separation film of Example R4 was obtained.

### Example R5

The coating solution A-1 shown in Table 1 was applied to a PET rubbing-treated surface which is subjected to the rubbing treatment and manufactured by Fujifilm Holdings Corporation using a wire bar at a room temperature so that a thickness of a dry film after performing the drying was 5 μm. After drying the coated layer for 30 seconds at the room temperature, the coated layer was heated for 2 minutes in the atmosphere at 85° C. and UV-irradiated using a D bulb (lamp 90 mW/cm) manufactured by Fusion UV Inc., for 6 to 12 seconds with output of 60% at 30° C., and a liquid crystal layer was obtained. The coating solution A-2 shown in Table 1 was applied onto this liquid crystal layer at the room temperature so that a thickness of a dry film after performing the drying was 5 μm, and the coated layer was dried, heated, and UV-irradiated in the same manner as described above, to form a liquid crystal layer as a second layer. Liquid crystal layers as third to fourteenth layers were formed on the second liquid crystal layer, by the same step described above using each of coating solutions A-3 to A-14 shown in Table 1, and a circularly polarized light separation layer was obtained.

The manufactured circularly polarized light separation layer was bonded to a visible light reflection layer which was the same visible light reflection layer manufactured in Example R1 by the same method as in Example R1, and a circularly polarized light separation film of Example R5 was obtained.

### Example R6

A coating solution A-15 shown in Table 1 was applied to a PET rubbing-treated surface which is subjected to the rubbing treatment and manufactured by Fujifilm Holdings Corporation using a wire bar at a room temperature so that a thickness of a dry film after performing the drying was 5 μm. After drying the coated layer for 30 seconds at the room temperature, the coated layer was heated for 2 minutes in the atmosphere at 85° C. and UV-irradiated using a D bulb (lamp 90 mW/cm) manufactured by Fusion UV Inc., for 6 to 12 seconds with output of 60% at 30° C., and a liquid crystal layer was obtained. A coating solution A-16 shown in Table 1 was applied onto this liquid crystal layer at the room temperature so that a thickness of a dry film after performing the drying was 5 μm, and the coated layer was dried, heated, and UV-irradiated in the same manner as described above, to form a liquid crystal layer as a second layer, and a circularly polarized light separation layer was obtained.

The manufactured circularly polarized light separation layer was bonded to a visible light reflection layer which was the same visible light reflection layer manufactured in Example R1 by the same method as in Example R1, and a circularly polarized light separation film of Example R6 was obtained.

### Example R7

The coating solution B-1 shown in Table 2 was applied to a PET rubbing-treated surface which is subjected to the rubbing treatment and manufactured by Fujifilm Holdings Corporation using a wire bar at the room temperature so that a thickness of a dry film after performing the drying was 2 μm. After drying the coated layer for 30 seconds at the room temperature, the coated layer was heated for 2 minutes in the atmosphere at 85° C. and UV-irradiated using a D bulb (lamp 90 mW/cm) manufactured by Fusion UV Inc., for 6 to 12 seconds with output of 60% at 30° C., and a liquid crystal layer was obtained. The coating solution B-2 shown in Table 2 was applied onto this liquid crystal layer at the room temperature so that a thickness of a dry film after performing the drying was 2 μm, and the coated layer was dried, heated, and UV-irradiated in the same manner as described above, to form a liquid crystal layer as a second layer. Liquid crystal layers as third to tenth layers were formed on the second liquid crystal layer, by the same step described above using each of the coating solutions B-3 to B-5 and B-9 to B-13 shown in Table 2, and a visible light reflection layer was obtained.

The manufactured visible light reflection layer was bonded to a circularly polarized light separation layer which was the same circularly polarized light separation layer as that manufactured in Example R1 by the same method as in Example R1, and a circularly polarized light separation film of Example R7 was obtained.

### Example R8

The coating solution B-1 shown in Table 2 was applied to a PET rubbing-treated surface which is subjected to the rubbing treatment and manufactured by Fujifilm Holdings Corporation using a wire bar at the room temperature so that a thickness of a dry film after performing the drying was 2 μm. After drying the coated layer for 30 seconds at the room temperature, the coated layer was heated for 2 minutes in the atmosphere at 85° C. and UV-irradiated using a D bulb (lamp 90 mW/cm) manufactured by Fusion UV Inc., for 6 to 12 seconds with output of 60% at 30° C., and a liquid crystal layer was obtained. The coating solution B-2 shown in Table 2 was applied onto this liquid crystal layer at the room temperature so that a thickness of a dry film after performing the drying was 2 μm, and the coated layer was dried, heated, and UV-irradiated in the same manner as described above, to form a liquid crystal layer as a second layer. Liquid crystal layers as third to sixth layers were formed on the second liquid crystal layer, by the same step described above using each of the coating solutions B-3 and B-9 to B-11 shown in Table 2, and a visible light reflection layer was obtained.

The manufactured visible light reflection layer was bonded to a circularly polarized light separation layer which was the same circularly polarized light separation layer as that manufactured in Example R1 by the same method as in Example R1, and a circularly polarized light separation film of Example R8 was obtained.

### Example R9

The coating solution A-2 shown in Table 1 was applied to a PET rubbing-treated surface which is subjected to the rubbing treatment and manufactured by Fujifilm Holdings Corporation using a wire bar at a room temperature so that a thickness of a dry film after performing the drying was 5 μm. After drying the coated layer for 30 seconds at the room temperature, the coated layer was heated for 2 minutes in the atmosphere at 85° C. and UV-irradiated using a D bulb (lamp 90 mW/cm) manufactured by Fusion UV Inc., for 6 to 12 seconds with output of 60% at 30° C., and a circularly polarized light separation layer was obtained.

The manufactured circularly polarized light separation layer was bonded to a visible light reflection layer which was the same visible light reflection layer manufactured in Example R1 by the same method as in Example R1, and a circularly polarized light separation film of Example R9 was obtained.

### Example R10

The coating solution B-1 shown in Table 2 was applied to a PET rubbing-treated surface which is subjected to the rubbing treatment and manufactured by Fujifilm Holdings Corporation using a wire bar at the room temperature so that a thickness of a dry film after performing the drying was 2 μm. After drying the coated layer for 30 seconds at the room temperature, the coated layer was heated for 2 minutes in the atmosphere at 85° C. and UV-irradiated using a D bulb (lamp 90 mW/cm) manufactured by Fusion UV Inc., for 6 to 12 seconds with output of 60% at 30° C., and a liquid crystal layer was obtained. The coating solution B-9 shown in Table 2 was applied onto this liquid crystal layer at the room temperature so that a thickness of a dry film after performing the drying was 2 μm, and the coated layer was dried, heated, and UV-irradiated in the same manner as described above, to form a liquid crystal layer as a second layer, and a visible light reflection layer was obtained.

The manufactured visible light reflection layer was bonded to a circularly polarized light separation layer which was the same circularly polarized light separation layer as that manufactured in Example R1 by the same method as in Example R1, and a circularly polarized light separation film of Example R10 was obtained.

### Example R11

A coating solution C shown in Table 3 was spin-applied to a PET rubbing-treated surface which is subjected to the rubbing treatment and manufactured by Fujifilm Holdings Corporation at a rotation rate of 2000 rpm. After drying the coated layer for 30 seconds at the room temperature, the coated layer was heated for 2 minutes in the atmosphere at 85° C. and UV-irradiated using a D bulb (lamp 90 mW/cm) manufactured by Fusion UV Inc., for 6 to 12 seconds with output of 60% at 30° C., and a phase difference film was formed.

A phase difference of this phase difference film was measured in a range of 400 nm to 800 nm using an AxoScan manufactured by Axometrics, Inc., and when a phase difference at 880 nm was acquired using the values by an extrapolation method, a phase difference at 220 nm was obtained.

An UV curable adhesive Exp. U12034-6 manufactured by DIC Corporation was applied to a phase difference film surface of this film using a wire bar at the room temperature so that a thickness of a dry film after performing the drying was 5 μm. A near infrared linear polarizing film manufactured by Edmund Optics Japan was bonded so that an angle formed by an orientation axis of the liquid crystal molecules and an absorption axis of the polarizing plate in the plane was 45 degrees, and a circularly polarizing plate was formed. It was confirmed that this circularly polarizing plate was a right circularly polarizing plate, by measuring Circular Polarizance by setting the polarizing plate on the light incident side, using the AxoScan.

A surface of the visible light reflection layer on the liquid crystal layer side which is manufactured in Example R1 was bonded onto a surface of a linear polarizing plate of the manufactured circularly polarized light separation layer by the same method as in Example R1, and a circularly polarized light separation film of Example R11 was obtained.

### Comparative Example R1

Only the circularly polarized light separation layer manufactured in Example R9 was used.

### Comparative Example R2

Only the circularly polarized light separation layer manufactured in Example R1 was used.

### Comparative Example R3

An UV curable adhesive Exp. U12034-6 manufactured by DIC Corporation was applied onto IR 80 (visible light absorption layer) manufactured by Fujifilm Holdings Corporation using a wire bar at a room temperature so that a thickness of a dry film after performing the drying was 5 μm. This coated surface and the liquid crystal layer side of a circularly polarized light separation layer manufactured in the same manner as in Example R1 were bonded to each other so that air bubbles were not generated, and were UV-irradiated using a D bulb (lamp 90 mW/cm) manufactured by Fusion UV Inc., for 6 to 12 seconds with output of 60% at 30° C. The PET manufactured by Fujifilm Holdings Corporation which was the support of the circularly polarized light separation layer was peeled off, and a circularly polarized light separation film of Comparative Example R3 was obtained.

### Comparative Example A1

An UV curable adhesive. Exp. U12034-6 manufactured by DIC Corporation was applied to IR80 manufactured by Fujifilm Holdings Corporation as a visible light absorption layer using a wire bar at a room temperature so that a thickness of a dry film after performing the drying was 5 μm. This coated surface and the surface of a circularly polarized light separation layer on the liquid crystal layer side manufactured in the same manner as in Example R1 were bonded to each other so that air bubbles were not generated, and were UV-irradiated using a D bulb (lamp 90 mW/cm) manufactured by Fusion UV Inc., for 6 to 12 seconds with output of 60% at 30° C. Then, the PET manufactured by Fujifilm Holdings Corporation which was the support of the circularly polarized light separation layer was peeled off, and a circularly polarized light separation film of Example A1 was obtained

### Example A2

A circularly polarized light separation layer manufactured in the same manner as in Example R2 was bonded to IR80 manufactured by Fujifilm. Holdings Corporation by the same method as in Example A1, and a circularly polarized light separation film of Example A2 was obtained.

### Example A3

A circularly polarized light separation layer manufactured in the same manner as in Example R3 was bonded to IR80 manufactured by Fujifilm Holdings Corporation by the same method as in Example A1, and a circularly polarized light separation film of Example A3 was obtained.

### Example A4

A circularly polarized light separation layer manufactured in the same manner as in Example R4 was bonded to IR80 manufactured by Fujifilm Holdings Corporation by the same method as in Example A1, and a circularly polarized light separation film of Example A4 was obtained.

### Example A5

A circularly polarized light separation layer manufactured in the same manner as in Example R5 was bonded to IR80 manufactured by Fujifilm Holdings Corporation by the same method as in Example A1, and a circularly polarized light separation film of Example A5 was obtained.

### Example A6

The coating solution A-14 shown in Table 1 was applied to a PET rubbing-treated surface which is subjected to the rubbing treatment and manufactured by Fujifilm Holdings Corporation using a wire bar at a room temperature so that a thickness of a dry film after performing the drying was 5 μm. After drying the coated layer for 30 seconds at the room temperature; the coated layer was heated for 2 minutes in the atmosphere at 85° C. and UV-irradiated using a D bulb (lamp 90 mW/cm) manufactured by Fusion UV Inc., for 6 to 12 seconds with output of 60% at 30° C., and a liquid crystal layer was obtained. The coating solution A-15 shown in Table 1 was applied onto this liquid crystal layer at the room temperature so that a thickness of a dry film after performing the drying was 5 μm, and the coated layer was dried, heated, and UV-irradiated in the same manner as described above, to form a liquid crystal layer as a second layer, and a circularly polarized light separation layer was obtained.

The manufactured circularly polarized light separation layer was bonded to IR80 manufactured by Fujifilm Holdings Corporation by the same method as in Example A1, and a circularly polarized light separation film of Example A6 was obtained.

### Example A7

A circularly polarized light separation film of Example A7 was obtained by the same method as in example A1, except for using SC60 manufactured by Fujifilm Holdings Corporation as a visible light absorption layer.

### Example A8

A circularly polarized light separation film of Example A8 was obtained by the same method as in example A1, except for using SC46 manufactured by Fujifilm Holdings Corporation as a visible light absorption layer.

### Example A9

A circularly polarized light separation layer manufactured in the same manner as in Example R9 was bonded to IR80 manufactured by Fujifilm Holdings Corporation by the same method as in Example A1, and a circularly polarized light separation film of Example A9 was obtained.

### Example A10

A circularly polarized light separation film of Example A10 was obtained by the same method as in example A1, except for using SC42 manufactured by Fujifilm Holdings Corporation as a visible light absorption layer.

### Example A11

The coating solution C shown in Table 3 was spin-applied to a PET rubbing-treated surface which is subjected to the rubbing treatment and manufactured by Fujifilm Holdings Corporation at a rotation rate of 2000 rpm. After drying the coated layer for 30 seconds at the room temperature, the coated layer was heated for 2 minutes in the atmosphere at 85° C. and UV-irradiated using a D bulb (lamp 90 mW/cm) manufactured by Fusion UV Inc., for 6 to 12 seconds with output of 60% at 30° C., and a phase difference film was formed.

A phase difference of this phase difference film was measured in a range of 400 nm to 800 nm using an AxoScan manufactured by Axometrics, Inc., and when a phase difference at 880 nm was acquired using the values by an extrapolation method, a phase difference at 220 nm was obtained.

An UV curable adhesive Exp. U12034-6 manufactured by DIC Corporation was applied to a phase difference film surface of this film using a wire bar at the room temperature so that a thickness of a dry film after performing the drying was 5 μm. A near infrared linear polarizing film manufactured by Edmund Optics Japan was bonded so that an angle formed by an orientation axis of the liquid crystal molecules and an absorption axis of the polarizing plate in the plane was 45 degrees, and a circularly polarizing plate was formed. It was confirmed that this circularly polarizing plate was a right circularly polarizing plate, by measuring Circular Polarizance by setting the polarizing plate on the light emission side, using the AxoScan.

An UV curable adhesive Exp. U12034-6 manufactured by DIC Corporation was applied to IR80 manufactured by Fujifilm Holdings Corporation using a wire bar at a room temperature so that a thickness of a dry film after performing the drying was 5 μm. This coated surface and the surface of the linear polarizing plate of the manufactured circularly polarized light separation layer were bonded to each other so that air bubbles were not generated, and were UV-irradiated using a D bulb (lamp 90 mW/cm) manufactured by Fusion UV Inc., for 6 to 12 seconds with output of 60% at 30° C., and a circularly polarized light separation film of Example A11 was obtained.

### Comparative Example A1

Only the circularly polarized light separation layer manufactured in Example R9 was used.

### Comparative Example A2

Only the circularly polarized light separation layer manufactured in Example R1 was used.

Measurement Method

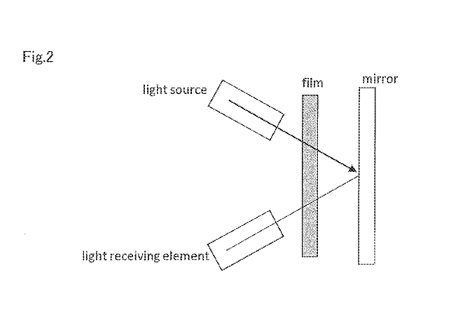

Films manufactured above, a mirror, the light source (KED880S4 manufactured by Kyosemi Corporation), and the light receiving element (KS1364 manufactured by DENSHI CO, LTD.) were arranged as shown in FIG. 2. In addition, the film was arranged so that the visible light shielding layer (visible light reflection layer or the visible light absorption layer) was on the light source and the light receiving element side and the circularly polarized light separation layer was on the mirror side. A unpolarized light beam mainly of 880 nm wavelength was emitted from the light source with respect to a mirror through the film; and light which was the light reflected by the mirror and transmitted through the film was sensed by the light receiving element and evaluated. By setting a value measured in a state without the film as 100, measured values obtained when the film was installed were corrected. A lower value showed that the effects were obtained. The evaluation criteria are as follows. In a darkroom, the measurement was performed in a state where the light was completely shielded, and in a lit room, the measurement was performed in a state where an incandescent lamp was turned on.

AA: from 0 to 5

A: from 5 to 20

B: from 20 to 50

C: from 50 to 100

The evaluation of durability was performed by executing the measurement described above after continuously emitting 40 W halogen lamp for 1000 hours, and when the variation in numerical values was within 5, the result was evaluated as A, and when the variation in numerical values was equal to or greater than 5, the result was evaluated as C. The appearance was visually evaluated, and the mirror-like state was evaluated as A and others were evaluated as C.

The results are shown in Tables 4 to 5.

TABLE 1
Coating Solution (A)

| | Material name | Coating | Coating | Coating | Coating | Coating |
|---|---|---|---|---|---|---|
| Material (types) | (manufacturer) | solution A-1 | solution A-2 | solution A-3 | solution A-4 | solution A-5 |
| Liquid crystal | Compound 1 | 100 parts by mass | 100 parts by mass | 100 parts by mass | 100 parts by mass | 100 parts by mass |
| compound | | | | | | |
| Polymerization | Irg-819 (Ciba | 4 parts by mass | 4 parts by mass | 4 parts by mass | 4 parts by mass | 4 parts by mass |
| initiator | Specialty | | | | | |
| | Chemicals) | | | | | |
| Orientation | Compound 2 | 0.03 parts by mass | 0.03 parts by mass | 0.03 parts by mass | 0.03 parts by mass | 0.03 parts by mass |
| controlling agent | | | | | | |
| Chiral agent | LC-756 (BASF) | 3.7 parts by mass | 3.5 parts by mass | 3.3 parts by mass | 3.1 parts by mass | 2.9 parts by mass |
| Solvent | 2-Butanone (Wako | Suitably adjusted | Suitably adjusted | Suitably adjusted | Suitably adjusted | Suitably adjusted |
| | Pure Chemical | according to film | according to film | according to film | according to film | according to film |
| | Industries, Ltd.) | thickness | thickness | thickness | thickness | thickness |
| | Material name | Coating solution | Coating solution | Coating solution | Coating solution | Coating solution |
| Material (types) | (manufacturer) | A-6 | A-7 | A-8 | A-9 | A-10 |
| Liquid crystal | Compound 1 | 100 parts by mass | 100 parts by mass | 100 parts by mass | 100 parts by mass | 100 parts by mass |
| compound | | | | | | |
| Polymerization | Irg-819 (Ciba | 4 parts by mass | 4 parts by mass | 4 parts by mass | 4 parts by mass | 4 parts by mass |
| initiator | Specialty | | | | | |
| | Chemicals) | | | | | |
| Orientation | Compound 2 | 0.03 parts by mass | 0.03 parts by mass | 0.03 parts by mass | 0.03 parts by mass | 0.03 parts by mass |
| controlling agent | | | | | | |
| Chiral agent | LC-756 (BASF) | 2.8 parts by mass | 2.7 parts by mass | 2.6 parts by mass | 2.4 parts by mass | 2.3 parts by mass |
| Solvent | 2-Butanone (Wako | Suitably adjusted | Suitably adjusted | Suitably adjusted | Suitably adjusted | Suitably adjusted |
| | Pure Chemical | according to film | according to film | according to film | according to film | according to film |
| | Industries, Ltd.) | thickness | thickness | thickness | thickness | thickness |

| | Material name | | | | |
|---|---|---|---|---|---|
| Material (types) | (manufacturer) | Coating solution A-11 | Coating solution A-12 | Coating solution A-13 | Coating solution A-14 |
| Liquid crystal | Compound 1 | 100 parts by mass | 100 parts by mass | 100 parts by mass | 100 parts by mass |
| compound | | | | | |
| Polymerization initiator | Irg-819 (Ciba Specialty | 4 parts by mass | 4 parts by mass | 4 parts by mass | 4 parts by mass |
| | Chemicals) | | | | |
| Orientation controlling | Compound 2 | 0.03 parts by mass | 0.03 parts by mass | 0.03 parts by mass | 0.03 parts by mass |
| agent | | | | | |
| Chiral agent | LC-756 (BASF) | 2.1 parts by mass | 2.0 parts by mass | 1.9 parts by mass | 1.8 parts by mass |
| Solvent | 2-Butanone (Wako Pure | Suitably adjusted | Suitably adjusted | Suitably adjusted | Suitably adjusted |
| | Chemical Industries, | according to film | according to film | according to film | according to film |
| | Ltd.) | thickness | thickness | thickness | thickness |

| Material (types) | Material name (manufacturer) | Coating solution A-15 | Coating solution A-16 |
|---|---|---|---|
| Liquid crystal compound | Compound 1 | 100 parts by mass | 100 parts by mass |
| Polymerization initiator | Irg-819 (Ciba Specialty Chemicals) | 4 parts by mass | 4 parts by mass |
| Orientation controlling agent | Compound 2 | 0.03 parts by mass | 0.03 parts by mass |
| Chiral agent | Compound 3 | 5.5 parts by mass | 5.2 parts by mass |
| Solvent | 2-Butanone (Wako Pure Chemical | Suitably adjusted according to film | Suitably adjusted according to film |
| | Industries, Ltd.) | thickness | thickness |

TABLE 2
Coating solution (B)

| | Material name | Coating solution | Coating solution | Coating solution | Coating solution |
|---|---|---|---|---|---|
| Material (types) | (manufacturer) | B-1 | B-2 | B-3 | B-4 |
| Liquid crystal | Compound 1 | 100 parts by mass | 100 parts by mass | 100 parts by mass | 100 parts by mass |
| compound | | | | | |
| Polymerization | Irg-819 (Ciba Specialty | 4 parts by mass | 4 parts by mass | 4 parts by mass | 4 parts by mass |
| initiator | Chemicals) | | | | |
| Orientation | Compound 2 | 0.03 parts by mass | 0.03 parts by mass | 0.03 parts by mass | 0.03 parts by mass |
| controlling agent | | | | | |
| Chiral agent | LC-756 (BASF) | 7.6 parts by mass | 6.7 parts by mass | 6.0 parts by mass | 5.4 parts by mass |
| Solvent | 2-Butanone (Wako Pure | Suitably adjusted | Suitably adjusted | Suitably adjusted | Suitably adjusted |
| | Chemical Industries, | according to film | according to film | according to film | according to film |
| | Ltd.) | thickness | thickness | thickness | thickness |
| | Material name | Coating solution | Coating solution | Coating solution | Coating solution |
| Material (types) | (manufacturer) | B-5 | B-6 | B-7 | B-8 |
| Liquid crystal | Compound 1 | 100 parts by mass | 100 parts by mass | 100 parts by mass | 100 parts by mass |
| compound | | | | | |
| Polymerization | Irg-819 (Ciba | 4 parts by mass | 4 parts by mass | 4 parts by mass | 4 parts by mass |
| initiator | Specialty Chemicals) | | | | |
| Orientation | Compound 2 | 0.03 parts by mass | 0.03 parts by mass | 0.03 parts by mass | 0.03 parts by mass |
| controlling agent | | | | | |
| Chiral agent | LC-756 (BASF) | 5.0 parts by mass | 4.6 parts by mass | 4.2 parts by mass | 3.9 parts by mass |
| Solvent | 2-Butanone (Wako | Suitably adjusted | Suitably adjusted | Suitably adjusted | Suitably adjusted |
| | Pure Chemical | according to film | according to film | according to film | according to film |
| | Industries, Ltd.) | thickness | thickness | thickness | thickness |
| | Material name | | Coating solution | Coating solution | Coating solution |
| Material (types) | (manufacturer) | Coating solution B-9 | B-10 | B-11 | B-12 |
| Liquid crystal | Compound 1 | 100 parts by mass | 100 parts by mass | 100 parts by mass | 100 parts by mass |
| compound | | | | | |
| Polymerization | Irg-819 (Ciba | 4 parts by mass | 4 parts by mass | 4 parts by mass | 4 parts by mass |
| initiator | Specialty Chemicals) | | | | |
| Orientation | Compound 2 | 0.03 parts by mass | 0.03 parts by mass | 0.03 parts by mass | 0.03 parts by mass |
| controlling agent | | | | | |
| Chiral agent | Compound 3 | 12.5 parts by mass | 11.0 parts by mass | 9.8 parts by mass | 8.8 parts by mass |
| Solvent | 2-Butanone (Wako | Suitably adjusted | Suitably adjusted | Suitably adjusted | Suitably adjusted |
| | Pure Chemical | according to film | according to film | according to film | according to film |
| | Industries, Ltd.) | thickness | thickness | thickness | thickness |
| | Material name | Coating solution | Coating solution | Coating solution | Coating solution |
| Material (types) | (manufacturer) | B-13 | B-14 | B-15 | B-16 |
| Liquid crystal | Compound 1 | 100 parts by mass | 100 parts by mass | 100 parts by mass | 100 parts by mass |
| compound | | | | | |
| Polymerization | Irg-819 (Ciba | 4 parts by mass | 4 parts by mass | 4 parts by mass | 4 parts by mass |
| initiator | Specialty Chemicals) | | | | |
| Orientation | Compound 2 | 0.03 parts by mass | 0.03 parts by mass | 0.03 parts by mass | 0.03 parts by mass |
| controlling agent | | | | | |
| Chiral agent | Compound 3 | 8.0 parts by mass | 7.3 parts by mass | 6.8 parts by mass | 6.3 parts by mass |
| Solvent | 2-Butanone (Wako | Suitably adjusted | Suitably adjusted | Suitably adjusted | Suitably adjusted |
| | Pure Chemical | according to film | according to film | according to film | according to film |
| | Industies, Ltd.) | thickness | thickness | thickness | thickness |

TABLE 3
Coating Solution (C)

| Material (types) | Material name (manufacturer) | Coating solution C |
|---|---|---|
| Liquid crystal compound | Compound 1 | 100 parts by mass |
| Polymerization initiator | Irg-819 (Ciba Specialty Chemicals) | 4 parts by mass |
| Orientation controlling agent | Compound 2 | 0.03 parts by mass |
| Solvent | 2-Butanone (Wako Pure Chemical Industries, Ltd.) | Suitably adjusted according |
| | | to film thickness |

Compound 1

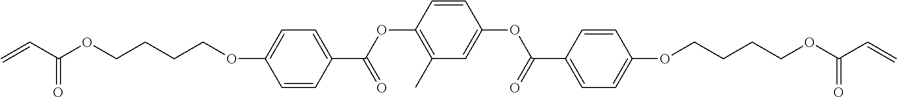 [SMILES: C=CC(=O)OCCCCOc1ccc(C(=O)Oc2ccc(OC(=O)c3ccc(OCCCCOC(=O)C=C)cc3)c(C)c2)cc1]

Compound 2 (see JP2005-99248A)

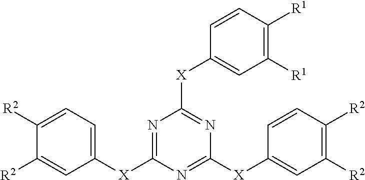

| R¹ | R² | X |
|---|---|---|
| O(CH₂)₂O(CH₂)₂(CF₂)₀F | O(CH₂)₂O(CH₂)₂(CF₂)₀F | NH |

Compound 3

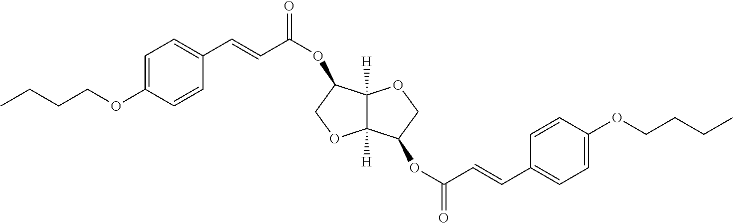 [SMILES: CCCCOc1ccc(/C=C/C(=O)O[C@@H]2CO[C@H]3[C@@H]2OC[C@H]3OC(=O)/C=C/c2ccc(OCCCC)cc2)cc1]

TABLE 4

| | Visible light absorption layer | | | | Circularly polarized light separation layer | | | | | | | | | |
|---|---|---|---|---|---|---|---|---|---|---|---|---|---|---|
| | | Short | Long | Wavelength | | | Short | Long | Wavelength | | | | | Deter- |
| | | wave | wave | bandwidth | | Right | wave | wave | bandwidth | | Lit | Dura- | Appear- | mina- |
| | Cut type | [nm] | [nm] | [nm] | Method | or left | [nm] | [nm] | [nm] | Darkroom | room | bility | ance | tion |
| Ex. R1 | Reflection | 380 | 780 | 400 | Cholesteric | Right | 850 | 910 | 60 | A | A | A | A | A |
| Ex. R2 | Reflection | 380 | 780 | 400 | Cholesteric | Right | 800 | 910 | 110 | AA | AA | A | A | A |
| Ex. R3 | Reflection | 380 | 780 | 400 | Cholesteric | Right | 800 | 1200 | 400 | AA | AA | A | A | A |
| Ex. R4 | Reflection | 380 | 780 | 400 | Cholesteric | Right | 800 | 1500 | 700 | A | A | A | A | A |
| Ex. R5 | Reflection | 380 | 780 | 400 | Cholesteric | Right | 800 | 1700 | 900 | B | B | A | A | B |
| Ex. R6 | Reflection | 380 | 780 | 400 | Cholesteric | Left | 850 | 910 | 60 | A | A | A | A | A |
| Ex. R7 | Reflection | 380 | 600 | 220 | Cholesteric | Right | 850 | 910 | 60 | A | A | A | A | A |
| Ex. R8 | Reflection | 380 | 460 | 80 | Cholesteric | Right | 850 | 910 | 60 | A | B | A | A | A |
| Ex. R9 | Reflection | 380 | 780 | 400 | Cholesteric | Right | 850 | 890 | 40 | B | B | A | A | B |
| Ex. | Reflection | 380 | 420 | 40 | Cholesteric | Right | 850 | 910 | 60 | A | B | A | A | B |
| R10 | | | | | | | | | | | | | | |
| Ex. | Reflection | 380 | 780 | 400 | λ/4 + | Right | 850 | 910 | 60 | A | A | A | A | A |
| R11 | | | | | linear | | | | | | | | | |
| | | | | | polarizing | | | | | | | | | |
| | | | | | plate | | | | | | | | | |
| Com. | None | | | | Cholesteric | Right | 850 | 890 | 40 | B | C | A | C | C |
| Ex. R1 | | | | | | | | | | | | | | |
| Com. | None | | | | Cholesteric | Right | 850 | 910 | 60 | A | C | A | C | C |
| Ex. R2 | | | | | | | | | | | | | | |
| Com. | Absorption | 380 | 780 | 400 | Cholesteric | Right | 850 | 910 | 60 | A | A | C | C | C |
| Ex. R3 | | | | | | | | | | | | | | |

TABLE 5

| | Visible light absorption layer | | | | Near infrared polarized light separation layer | | | | | | | |
|---|---|---|---|---|---|---|---|---|---|---|---|---|
| | | Short | Long | Wavelength | | Right | Short | Long | Wavelength | | | |
| | | wave | wave | bandwidth | | or | wave | wave | bandwidth | | Lit | |
| | Cut type | [nm] | [nm] | [nm] | Method | left | [nm] | [nm] | [nm] | Darkroom | room | Determination |
| Ex. | Absorption | 380 | 780 | 400 | Cholesteric | Right | 850 | 910 | 60 | A | A | A |
| A1 | | | | | | | | | | | | |
| Ex. | Absorption | 380 | 780 | 400 | Cholesteric | Right | 800 | 910 | 110 | AA | AA | A |
| A2 | | | | | | | | | | | | |
| Ex. | Absorption | 380 | 780 | 400 | Cholesteric | Right | 800 | 1200 | 400 | AA | AA | A |
| A3 | | | | | | | | | | | | |
| Ex. | Absorption | 380 | 780 | 400 | Cholesteric | Right | 800 | 1500 | 700 | A | A | A |
| A4 | | | | | | | | | | | | |
| Ex. | Absorption | 380 | 780 | 400 | Cholesteric | Right | 800 | 1700 | 900 | B | B | B |
| A5 | | | | | | | | | | | | |
| Ex. | Absorption | 380 | 780 | 400 | Cholesteric | Left | 850 | 910 | 60 | A | A | A |
| A6 | | | | | | | | | | | | |
| Ex. | Absorption | 380 | 600 | 220 | Cholesteric | Right | 850 | 910 | 60 | A | A | A |
| A7 | | | | | | | | | | | | |
| Ex. | Absorption | 380 | 460 | 80 | Cholesteric | Right | 850 | 910 | 60 | A | B | A |
| A8 | | | | | | | | | | | | |
| Ex. | Absorption | 380 | 780 | 400 | Cholesteric | Right | 850 | 890 | 40 | B | B | B |
| A9 | | | | | | | | | | | | |
| Ex. | Absorption | 380 | 420 | 40 | Cholesteric | Right | 850 | 910 | 60 | A | B | B |
| A10 | | | | | | | | | | | | |
| Ex. | Absorption | 380 | 780 | 400 | λ/4 + linear | Right | 850 | 910 | 60 | A | A | A |
| A11 | | | | | polarizing | | | | | | | |
| | | | | | plate | | | | | | | |

| | | | | | | | | | |
|---|---|---|---|---|---|---|---|---|---|
| Com. | None | Cholesteric | Right | 850 | 890 | 40 | B | C | C |
| Ex. | | | | | | | | | |
| A1 | | | | | | | | | |
| Com. | None | Cholesteric | Right | 850 | 910 | 60 | A | C | C |
| Ex. | | | | | | | | | |
| A2 | | | | | | | | | |

[Preparation of Circularly Polarized Light Separation Film A]

A circularly polarized light separation film A was prepared in the same procedure as in the preparation of the circularly polarized light separation film of Example R1.

[Preparation of Circularly Polarized Light Separation Film B]

A circularly polarized light separation film B was prepared in the same procedure as in the preparation of the circularly polarized light separation film of Example A1.

[Preparation of Circularly Polarized Light Separation Film C]

A circularly polarized light separation film C was prepared in the same procedure as in the preparation of the circularly polarized light separation film of Example A2.

[Preparation of Circularly Polarized Light Separation Film D]

The coating solution A-15 shown in Table 1 was applied to a PET rubbing-treated surface which is subjected to the rubbing treatment and manufactured by Fujifilm Holdings Corporation using a wire bar at a room temperature so that a thickness of a dry film after performing the drying was 5 μm. After drying the coated layer for 30 seconds at the room temperature, the coated layer was heated for 2 minutes in the atmosphere at 85° C. and UV-irradiated using a D bulb (lamp 90 mW/cm) manufactured by Fusion UV Inc., for 6 to 12 seconds with output of 60% at 30° C., and a liquid crystal layer was obtained. The coating solution A-16 shown in Table 1 was applied onto this liquid crystal layer at the room temperature so that a thickness of a dry film after performing the drying was 5 μm, and the coated layer was dried, heated, and UV-irradiated in the same manner as described above, to form a liquid crystal layer as a second layer, and a circularly polarized light separation layer was obtained.

The manufactured circularly polarized light separation layer was bonded to IR80 manufactured by Fujifilm Holdings Corporation by the same method as for the circularly polarized light separation film B, and a circularly polarized light separation film D was obtained.

[Preparation of Circularly Polarized Light Separation Film E]

A circularly polarized light separation film E was prepared in the same procedure as in the preparation of the circularly polarized light separation film of Example A9.

[Preparation of Circularly Polarized Light Separation Film F]

A circularly polarized light separation film F was obtained in the same manner as in the manufacturing method of the circularly polarized light separation film A, except for not forming the visible light reflection layer.

[Preparation of Circularly Polarized Light Separation Film G]

A circularly polarized light separation film G was obtained in the same manner as in the manufacturing method of the circularly polarized light separation film C, except for not forming the visible light absorption layer.

[Preparation of Circularly Polarized Light Separation Film H]

A circularly polarized light separation film H was obtained in the same manner as in the manufacturing method of the circularly polarized light separation film D, except for not forming the visible light absorption layer.

[Preparation of Circularly Polarized Light Separation Film I]

A circularly polarized light separation film I was prepared in the same procedure as in the preparation of the circularly polarized light separation layer of Example R4.

[Preparation of Circularly Polarized Light Separation Film J]

A visible light absorption layer was formed on the circularly polarized light separation film I in the same manner as in the circularly polarized light separation film B, and a circularly polarized light separation film J was obtained.

[Preparation of Circularly Polarized Light Separation Film K]

A circularly polarized light separation film K was prepared in the same procedure as in the preparation of the circularly polarized light separation layer of Example R5.

[Preparation of Circularly Polarized Light Separation Film L]

A visible light absorption layer was formed on the circularly polarized light separation film K in the same manner as in the circularly polarized light separation film. B, and a circularly polarized light separation film L was obtained.

The circularly polarized light separation films A to L prepared as described above were arranged according to the arrangement diagrams of FIG. 1 corresponding to the numbers shown in Table 6, using the light source side (circularly polarized light separation film 1) and the light receiving element side (circularly polarized light separation film 2) as shown in Table 6, and the target objects in Examples 1 to 11 and Comparative Examples 1 to 5 shown in Table 6 were sensed. In addition, when the film including the visible light shielding layer and the circularly polarized light separation layer was used as the circularly polarized light separation film 1, the visible light shielding layer was disposed on the light source side and the circularly polarized light separation layer was disposed on the target object side, and when the film including the visible light shielding layer and the circularly polarized light separation layer was used as the circularly polarized light separation film 2, the visible light shielding layer was disposed on the light receiving element side and the circularly polarized light separation layer was disposed on the target object side.

Evaluation Method

In Examples 1 to 6, 10, and 11 and Comparative Examples 1 to 3, the evaluation was performed by comparing a signal strength ratio of a detector in cases where a detection target was inserted and not inserted in an optical path, under the lit room conditions.

In Examples 7 and 8 and Comparative Example 4, the evaluation was performed by comparing a signal strength ratio of a detector in cases where a detection target having cracks and a detection target having no cracks were inserted in an optical path, under the lit room conditions.

Evaluation criteria were as follows.

A: equal to or greater than 4

B: equal to or greater than 2 and smaller than 4

C: equal to or greater than 1.4 and smaller than 2

D: smaller than 1.4

In Example 9 and Comparative Example 5, water was sprayed to a raincoat in the darkroom and imaged by a camera. When a virtual image was captured, an evaluation of “fail” was made and when a virtual image was not observed, an evaluation of “success” was made.

In a darkroom, the measurement was performed in a state where the light was completely shielded, and in a lit room, the measurement was performed in a state where an incandescent lamp is turned on.

The results are shown in Table 6.

TABLE 6

| | Light source side (circularly polarized light separation film 1) | | | | | | | | | |
|---|---|---|---|---|---|---|---|---|---|---|
| | | | | | | Light | | | | |
| | | | | | | shielding | Light receiving element side | | | |
| | | | | | | layer | (circularly polarized | | | |
| | | | | | | shielding | light separation film 2) | | | |
| | | Circularly | Short | Long | Wavelength | wavelength | | Circularly | Short | Long |
| | Filter | polarizing | wave | wave | bandwidth | bandwidth | Filter | polarizing | wave | wave |
| | name | sense | [nm] | [nm] | [nm] | [nm] | name | sense | [nm] | [nm] |
| Ex. 1 | F | Right | 850 | 910 | 60 | None | D | Left | 850 | 910 |
| Ex. 2 | C | Right | 800 | 910 | 110 | 380-780 | C | Right | 800 | 910 |
| Ex. 3 | B | Right | 850 | 910 | 60 | 380-780 | B | Right | 850 | 910 |
| Ex. 4 | B | Right | 850 | 910 | 60 | 380-780 | B | Right | 850 | 910 |
| Ex. 5 | A | Right | 850 | 910 | 60 | 380-780 | A | Right | 850 | 910 |
| Ex. 6 | E | Right | 850 | 890 | 40 | 380-780 | E | Right | 850 | 890 |
| Ex. 7 | C | Right | 800 | 910 | 110 | 380-780 | C | Right | 800 | 910 |
| Ex. 8 | C | Right | 800 | 910 | 110 | 380-780 | C | Right | 800 | 910 |
| Ex. 9 | G | Right | 800 | 910 | 110 | None | C | Right | 800 | 910 |
| Ex. | I | Right | 800 | 1500 | 700 | None | J | Right | 800 | 1500 |
| 10 | | | | | | | | | | |
| Ex. | K | Right | 800 | 1700 | 900 | None | L | Right | 800 | 1700 |
| 11 | | | | | | | | | | |
| Com. | F | Right | 850 | 910 | 60 | None | H | Left | 850 | 910 |
| Ex. 1 | | | | | | | | | | |
| Com. | G | Right | 800 | 910 | 110 | None | G | Right | 800 | 910 |
| Ex. 2 | | | | | | | | | | |
| Com. | F | Right | 850 | 910 | 60 | None | F | Right | 850 | 910 |
| Ex. 3 | | | | | | | | | | |
| Com. | G | Right | 800 | 910 | 110 | None | G | Right | 800 | 910 |
| Ex. 4 | | | | | | | | | | |
| Com. | G | Right | 800 | 910 | 110 | None | G | Right | 800 | 910 |
| Ex. 5 | | | | | | | | | | |

| | Light receiving | | | | | | |
|---|---|---|---|---|---|---|---|
| | element side | | | | | | |
| | (circularly polarized light | | | | | | |
| | separation film 2) | | | | | | |
| | | Light | | | | | |
| | | shielding | | | | | |
| | | layer | | | | | |
| | | shielding | | | | | |
| | Wavelength | wavelength | | | | | |
| | bandwidth | bandwidth | Arrangement | Tilt of | | Arrangement | Detection |
| | [nm] | [nm] | diagram | film | Result | diagram | target |
| Ex. 1 | 60 | 380-780 | 1 | None | A | Transmission | PET film |
| | | | | | | type | |
| Ex. 2 | 110 | 380-780 | 4 | None | B | Reflection | |
| Ex. 3 | 60 | 380-780 | 2 | None | B | type | Copy |
| Ex. 4 | 60 | 380-780 | 2 | Tilted | A | | sheet |
| Ex. 5 | 60 | 380-780 | 2 | Tilted | A | | |
| Ex. 6 | 40 | 380-780 | 2 | None | C | | |
| Ex. 7 | 110 | 380-780 | 3 | None | C | | Si wafer |
| Ex. 8 | 110 | 380-780 | 3 | Tilted | B | | on which |
| | | | | | | | cracks |
| | | | | | | | are |
| | | | | | | | generated |
| Ex. 9 | 110 | 380-780 | 5 | None | Success | | Person |
| | | | | | | | wearing |
| | | | | | | | raincoat |
| | | | | | | | in the |
| | | | | | | | rain |
| Ex. | 700 | 380-780 | 2 | Tilted | A | | Copy |
| 10 | | | | | | | sheet |
| Ex. | 900 | 380-780 | 2 | Tilted | C | | |
| 11 | | | | | | | |
| Com. | 60 | None | I | None | D | Transmission | PET |
| Ex. 1 | | | | | | type | |
| Com. | 110 | None | 4 | None | D | Reflection | |
| Ex. 2 | | | | | | type | |
| Com. | 60 | None | 2 | None | D | | Copy |
| Ex. 3 | | | | | | | sheet |
| Com. | 110 | None | 3 | Tilted | D | | Si wafer |
| Ex. 4 | | | | | | | on which |
| | | | | | | | cracks |
| | | | | | | | are |
| | | | | | | | generated |
| Com. | 110 | None | 5 | None | Failure | | Person |
| Ex. 5 | | | | | | | wearing |
| | | | | | | | raincoat |
| | | | | | | | in the |
| | | | | | | | rain |

### EXPLANATION OF REFERENCES

1: circularly polarized light separation film
2: light source
3: light receiving element (detector)
4: target object
5: transparent glass

What is claimed is:

1. A circularly polarized light separation film which selectively allows the transmission of any one of right circularly polarized light and left circularly polarized light in at least a part of a near infrared light wavelength range, the film comprising:
a visible light shielding layer which reflects or absorbs light in at least a part of a visible light wavelength range; and
a circularly polarized light separation layer which selectively allows the transmission of any one of right circularly polarized light and left circularly polarized light in at least a part of a near infrared light wavelength range.

2. The circularly polarized light separation film according to claim 1,
wherein the visible light shielding layer is a visible light reflection layer selected from a group consisting of a layer obtained by fixing a cholesteric liquid-crystalline phase and a dielectric multilayer film.

3. The circularly polarized light separation film according to claim 1,
wherein the visible light shielding layer is a visible light absorption layercomprising a pigment or a dye.

4. The circularly polarized light separation film according to claim 1,
wherein the circularly polarized light separation layer is a layer obtained by fixing a cholesteric liquid-crystalline phase.

5. The circularly polarized light separation film according to claim 1,
wherein the circularly polarized light separation layer comprises a linearly polarized light separation layer and a layer having a phase difference (Re) in the range having a width equal to or greater than 50 nm from the range of a wavelength of 800 nm to 1500 nm is from 200 nm to 375 nm.

6. A manufacturing method of the circularly polarized light separation film according to claim,
wherein the circularly polarized light separation layer is formed by a method comprising the following (1) to (3):
(1) applying a liquid crystal composition comprising a polymerizable liquid crystal compound and a chiral agent to a base material;
(2) drying the liquid crystal composition coated on the base material in (1) to form a cholesteric liquid-crystalline phase; and
(3) fixing the cholesteric liquid-crystalline phase by heating or light irradiation, the manufacturing method further comprising:
bonding a visible light shielding layer to the surface of the layer obtained by fixing the cholesteric liquid-crystalline phase using an adhesive or
bonding a visible light shielding layer to the surface of the base material using an adhesive.

7. The manufacturing method of the circularly polarized light separation film according to claim 6,
wherein the circularly polarized light separation layer is formed by a method comprising the following (11) to (13):
(11) directly applying the liquid crystal composition comprising the polymerizable liquid crystal compound and the chiral agent to a surface of a layer obtained by fixing the cholesteric liquid-crystalline phase obtained in (3);
(12) drying the liquid crystal composition coated on the layer obtained by fixing the cholesteric liquid-crystalline phase obtained in (3) to form a cholesteric liquid-crystalline phase; and
(13) fixing the cholesteric liquid-crystalline phase formed in (12) by heating or light irradiation.

8. The manufacturing method according to claim 7,
wherein the polymerizable liquid crystal compound and the chiral agent of (1) are the same as the polymerizable liquid crystal compound and the chiral agent of (11), respectively.

9. A manufacturing method of the circularly polarized light separation film according to claim 4,
wherein the circularly polarized light separation layer is formed by a method comprising the following (21) to (23):
(21) applying a liquid crystal composition comprising a polymerizable liquid crystal compound and a chiral agent to a visible light shielding layer;
(22) drying the liquid crystal composition coated on the visible light shielding layer in (21) to form a cholesteric liquid-crystalline phase; and
(23) fixing the cholesteric liquid-crystalline phase by heating or light irradiation.

10. The manufacturing method of the circularly polarized light separation film according to claim 9,
wherein the circularly polarized light separation layer is formed by a method comprising the following (31) to (33):
(31) directly applying the liquid crystal composition comprising the polymerizable liquid crystal compound and the chiral agent to a surface of a layer obtained by fixing the cholesteric liquid-crystalline phase obtained in (23);
(32) drying the liquid crystal composition coated on the layer obtained by fixing the cholesteric liquid-crystalline phase obtained in (23) to form a cholesteric liquid-crystalline phase; and
(33) fixing the cholesteric liquid-crystalline phase formed in (32) by heating or light irradiation.

11. The manufacturing method according to claim 10,
wherein the polymerizable liquid crystal compound and the chiral agent of (21) are the same as the polymerizable liquid crystal compound and the chiral agent of (31), respectively.

12. An infrared sensor comprising:
the circularly polarized light separation film according to claim 1; and
a light receiving element which can detect light at a wavelength in which the circularly polarized light separation film selectively allows the transmission of any one of right circularly polarized light and left circularly polarized light.

13. A system for sensing a target object by irradiating the target object with light and detecting reflected light or transmitted light of the target object derived from the light irradiation, the system comprising:
a near infrared light source;
a circularly polarized light separation film 1;
a circularly polarized light separation film 2; and
a light receiving element which detects light at wavelengths of a near infrared light wavelength range,
wherein either of the circularly polarized light separation film 1 and the circularly polarized light separation film 2 selectively allows the transmission of either one of right circularly polarized light and left circularly polarized light at least in a part of a near infrared light wavelength range,
the circularly polarized light separation film 1 may serve as the circularly polarized light separation film 2,
the near infrared light source, the circularly polarized light separation film 1, the circularly polarized light separation film 2, and the light receiving element are arranged so that light supplied from the near infrared light source is transmitted through the circularly polarized light separation film 1 and is emitted to the target object and the light transmitted through or reflected by the target object is transmitted through the circularly polarized light separation film 2 and is detected by the light receiving element, and
the circularly polarized light separation film 2 is the circularly polarized light separation film according to claim 1.

14. A system for sensing a target object by irradiating the target object with light and detecting reflected light or transmitted light of the target object derived from the light irradiation, the system comprising:
a near infrared light source;
a circularly polarized light separation film 1;
a circularly polarized light separation film 2; and
a light receiving element which detects light at wavelengths of a near infrared light wavelength range,
wherein either of the circularly polarized light separation film 1 and the circularly polarized light separation film 2 selectively allows the transmission of either one of right circularly polarized light and left circularly polarized light at least in a part of a near infrared light wavelength range,
the circularly polarized light separation film 1 may serve as the circularly polarized light separation film 2,
the near infrared light source, the circularly polarized light separation film 1, the circularly polarized light separation film 2, and the light receiving element are arranged so that light supplied from the near infrared light source is transmitted through the circularly polarized light separation film 1 and is emitted to the target object and the light transmitted through or reflected by the target object is transmitted through the circularly polarized light separation film 2 and is detected by the light receiving element, and
the circularly polarized light separation film 1 and the circularly polarized light separation film 2 are the circularly polarized light separation films according to claim 1, respectively.

15. The system according to claim 13, which senses the target object through glass,
wherein the near infrared light source, the circularly polarized light separation film 1, the circularly polarized light separation film 2, and the light receiving element are arranged so that the reflected light of the target object derived from the light of the near infrared light source is transmitted through the circularly polarized light separation film 2 and is detected by the light receiving element.

16. The system according to claim 13,
wherein the target object is a transparent film, and
the near infrared light source, the circularly polarized light separation film 1, the circularly polarized light separation film 2, and the light receiving element are arranged so that the transmitted light of the target object derived from the light of the near infrared light source is transmitted through the circularly polarized light separation film 2 and is detected by the light receiving element.

17. The system according to claim 13,
wherein an optical axis of the reflected light or the transmitted light of the target object derived from the near infrared light source forms an angle of 70° to 89° to the circularly polarized light separation film 2.

18. A method of irradiating a target object and sensing the target object by reflected light or transmitted light of the target object derived from the light irradiation, the method comprising:
(1) irradiating the target object with circularly polarized light in a near infrared light wavelength range selectively comprising any one of right circularly polarized light and left circularly polarized light; and
(2) detecting light of which at least a part of light which is generated by reflection of the circularly polarized light by the target object or transmission of the circularly polarized light through the target object and is transmitted through a circularly polarized light separation layer 2 and a visible light shielding layer 2, by a light receiving element which detects light at wavelengths of the near infrared light wavelength range,
wherein the circularly polarized light separation layer 2 selectively allows the transmission of any one of right circularly polarized light and left circularly polarized light at least in a part of a near infrared light wavelength range, and
the visible light shielding layer 2 reflects or absorbs light in a wavelength range at least in a part of a visible light wavelength range.

19. The method according to claim 18,
wherein at least a part of the light beam which is generated by being reflected by the target object or being transmitted through the target object in (2) is transmitted through the circularly polarized light separation layer 2 and the visible light shielding layer 2 in this order.

20. The method according to claim 18,
wherein the circularly polarized light in the near infrared light wavelength range of (1) is light formed by being transmitted through a visible light shielding layer 1 and a circularly polarized light separation layer 1,
the circularly polarized light separation layer 1 is a layer which selectively allows the transmission of any one of right circularly polarized light and left circularly polarized light in at least a part of a near infrared light wavelength range, and may serve as the circularly polarized light separation layer 2, and
the visible light shielding layer 1 is a layer which reflects or absorbs light in a wavelength range at least in a part of a visible light wavelength range, and may serve as the visible light shielding layer 2.
